(19) United States
(12) Patent Application Publication
(10) Pub. No.: US 2017/0105129 A1
(43) Pub. Date: Apr. 13, 2017

(54) PROVISIONING AND COMMISSIONING RETROFITTED DEVICES

(71) Applicant: TerraLUX, Inc., Longmont, CO (US)

(72) Inventors: Charles Teplin, Boulder, CO (US); Steven G. Barge, Fort Collins, CO (US); Neil Cannon, Eldorado Springs, CO (US); Anthony W. Catalano, Boulder, CO (US); Steven S. Davis, Louisville, CO (US); Brent Ray Earl, Berthoud, CO (US); Elisabeth A, Schroeter, Frisco, CO (US)

(21) Appl. No.: 15/288,478

(22) Filed: Oct. 7, 2016

Related U.S. Application Data
(60) Provisional application No. 62/239,230, filed on Oct. 8, 2015.
(60) Provisional application No. 62/314,809, filed on Mar. 29, 2016.

(51) Int. Cl. H04W 24/02; G08C 23/02; G08C 17/02; H04L 12/24

(52) U.S. Cl. CPC H04W 24/02; H04L 41/0806; G08C 23/02; G08C 17/02

(57) ABSTRACT

A system and method are disclosed. The method includes retrofitting network-ready devices to a structure, and registering the devices on a device network in communication with a central application. The method includes causing the central application to associate a location of a device with the device, and to associate a human-understandable identifier with the device. The method includes causing the central application to associate the device with a network address, and causing the central application to: (a) group a first device with a second device, responsive to determining that the first device and the second device are in the same room, in the same service system, and/or of the same type; (b) assign a trigger to the first device; and (c) assign a first automated function to the first device and a second automated function to the second device, the automated functions responsive to the trigger of the first device.

### CLAIM OF PRIORITY UNDER 35 U.S.C. §119

The present Application for Patent claims priority to Provisional Application No. 62/239,230 entitled “PROVISIONING LED LIGHTS USING INDOOR MAPPING AND NAVIGATION” filed Oct. 8, 2015, and assigned to the assignee hereof and hereby expressly incorporated by reference herein.

The present Application also claims priority to Provisional Application No. 62/314,809 entitled “CLOULD-BASED LIGHTING SYSTEM” filed Mar. 29, 2016, and assigned to the assignee hereof and hereby expressly incorporated by reference herein.

### FIELD OF THE DISCLOSURE

The present disclosure relates generally to lighting systems, and more specifically to LED lighting systems that provide informational functionality.

### BACKGROUND

Lighting systems, and particularly LED lighting systems, are uniquely positioned within buildings in a way that allows them to provide functionality besides illumination. In particular, because individual LEDs are typically located in every room of a building, and because they are already connected to power sources, they can conveniently be connected to a variety of sensors for the purpose of measuring ambient information. The types of sensors that may be connected include those for detecting carbon dioxide or carbon monoxide, temperature, gaseous impurities such as volatile organics, motion, and ambient light, among many others.

Though existing LED systems connect to various sensors, these systems typically do not employ convenient ways to communication the information from each of the LEDs and sensors in a way that the data can be aggregated, analyzed, and used for useful purposes. Furthermore, it is often difficult to install and provision a large number of LED lights and sensors onto a wireless communication network.

Moreover, adaptive lighting control on a large scale may become more desirable in light of the energy crisis faced globally and the fact that lighting consumes a very large share of the energy used. Wireless LED lighting control systems have become more feature rich, as have the corresponding individual LED light engine controllers. As a result, the firmware complexity of LED light engine controllers has increased, facilitating the need to periodically update the light engine firmware. With hundreds or even thousands of LED light engine controllers installed in a building, using a microcontroller programming tool may quickly become an impractical or time-consuming method to commission and/or update the LED firmware.

Lighting or other building controls networks typically include gateways that communicate with end devices (e.g. sensors, individual lights, thermostats, etc.) and provide an internet connection that allows users interact with the end devices through a web application. Often, the gateway includes both an internet interface (WiFi or Ethernet) and a separate communication system for the end devices (e.g., a wired connection or a wireless connection). In large installations, multiple gateways are often required because either (1) gateways can only handle a limited number of end devices, or (2) gateways must be close enough to end devices to be in wireless reception range. In some cases, large numbers of gateways are undesirable because the internet connection is expensive to install, or IT departments believe that numerous new network devices are a nuisance and/or security concern.

In some known currently-available network systems, there may be two communication systems. The first is may be a single internet connection from a Hub Gateway (HUB GW). Typically, this is a TCP/IP connection through an Ethernet or WiFi connection. The second is the device network, which could be either wired or wireless (e.g., Zigbee, Bluetooth, Z-Wave, EnOcean, Thread, etc.). The device network is limited, either because gateways can only process a limited number of end devices or because gateways have limited physical range.

Therefore, a need exists for a system that remedies these issues and/or provides other new and innovative features or methods.

### SUMMARY

An exemplary method of installing devices on or in a structure is described. The method includes retrofitting a plurality of devices to a structure, the plurality of devices being network-ready, and causing a central application to execute the following: (a) register the plurality of devices on a device network, the device network in communication with the central application; (b) associate a location of at least one of the plurality of devices with the at least one of the plurality of devices; (c) associate a human-understandable identifier with the at least one of the plurality of devices; (d) associate the at least one of the plurality of devices with a network address; (e) group a first one of the plurality of devices with a second one of the plurality of devices, the grouping responsive to determining that the first one of the plurality of devices and the second one of the plurality of devices are at least one of in the same room, in the same service system, or of the same type; (f) assign a trigger to the first one of the plurality of devices; and (g) assign a first automated function to the first one of the plurality of devices and a second automated function to the second one of the plurality of devices, the automated functions of the first and second ones of the plurality of devices responsive to the trigger of the first one of the plurality of devices.

An exemplary system of devices coupled to a structure is also disclosed. The system has a plurality of devices installed on or in a structure, the plurality of devices being network-ready, and a central application comprising non-transitory processor-readable instructions or an FPGA for executing a method. The method includes: (a) registering the plurality of devices on a device network; (b) associating a location of at least one of the plurality of devices with the at least one of the plurality of devices; (c) associating a human-understandable identifier with the at least one of the plurality of devices; (d) associating the at least one of the plurality of devices with a network address; (e) grouping a first one of the plurality of devices with a second one of the plurality of devices, the grouping responsive to determining that the first one of the plurality of devices and the second one of the plurality of devices are at least one of in the same room, in the same service system, or of the same type; (f) assigning a trigger to the first one of the plurality of devices; and (g) assigning a first automated function to the first one of the plurality of devices and a second automated function to the second one of the plurality of devices, the automated functions of the first and second ones of the plurality of devices responsive to the trigger of the first one of the plurality of devices.

An exemplary central application for controlling a system of devices coupled to a structure is described. The system has a plurality of devices installed on or in a structure, the plurality of devices being network-ready. The central application has non-transitory processor-readable instructions or an FPGA for executing a method. The method includes: (a) registering the plurality of devices on a device network; (b) associating a location of at least one of the plurality of devices with the at least one of the plurality of devices; (c) associating a human-understandable identifier with the at least one of the plurality of devices; (d) associating the at least one of the plurality of devices with a network address; (e) grouping a first one of the plurality of devices with a second one of the plurality of devices, the grouping responsive to determining that the first one of the plurality of devices and the second one of the plurality of devices are at least one of in the same room, in the same service system, or of the same type; (f) assigning a trigger to the first one of the plurality of devices; and (g) assigning a first automated function to the first one of the plurality of devices and a second automated function to the second one of the plurality of devices, the automated functions of the first and second ones of the plurality of devices responsive to the trigger of the first one of the plurality of devices.

### BRIEF DESCRIPTION OF THE DRAWINGS

FIG. 1 illustrates a method for retrofitting a lighting system;

FIG. 2 illustrates a visualization of an imaging device;

FIG. 3 is a rendering of a 3D model generated with an imaging device;

FIG. 4 is a rendering of a 3D model generated with an imaging device;

FIG. 5 is a rendering of a 3D model including the structure of a building;

FIG. 6 illustrates an office wherein users are tracked via devices;

FIG. 7 illustrates an office with images or symbols of people to mark device locations;

FIG. 8 illustrates an audit of existing devices;

FIG. 9 illustrates an installation of retrofitted devices;

FIG. 10A illustrates a system to register retrofitted devices;

FIG. 10B illustrates a system to register retrofitted devices;

FIG. 10C illustrates a system to register retrofitted devices;

FIG. 11A illustrates a system for configuring a device network;

FIG. 11B illustrates a system for configuring a device network;

FIG. 11C illustrates a system for configuring a device network;

FIG. 12 illustrates a view of a 3D model of a room with networked devices;

FIG. 13 illustrates a networked system having increased wireless coverage;

FIG. 14 illustrates a diagram of a computer system;

FIG. 15 is a diagram of an exemplary lighting system;

FIG. 16 is a diagram of a building having an exemplary lighting system;

FIG. 17 illustrates logic of a controls-ready light source;

FIG. 18 illustrates logic of a commissioning device suitable for use in various embodiments;

FIG. 19 is a flowchart of an exemplary method;

FIG. 20 is a flowchart of another exemplary method;

TABLE 1 is a detailed example of specifying EPROM values;

FIG. 21 is a detailed example of an embodiment of the method illustrated in FIG. 20; and

FIG. 22 is an example of a system having a device network and a gateway network.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

For the purposes of this disclosure, a gateway is a device or module residing on a device that interfaces between two networks having different communication protocols. For instance, a gateway can interface communications between a local area network and the Internet, or between a device network (e.g., mesh network or other wireless network designed for low power requirements) and a local area network. A gateway can reside on a modem or a standalone device, to name two non-limiting examples. In some instances, a gateway can be a standalone device from a modem and router. In some cases a gateway and modem can reside between a device network and the Internet, and the modem can include a second gateway for interfacing to the Internet. A gateway can include a wired or wireless network interface and one or more antennas so as to act as an access point for other wired or wireless devices. In this way a gateway can include router functionality. A gateway can include a network connection to a local area network or the Internet as well as a networked device connection.

For the purposes of this disclosure, a building management system is a system configured to control lighting, HVAC, security, and other building functions. Such systems are often in place prior to a retrofit, and thus the retrofit may add functionality to a building management system or provide new control in parallel to but independent from the building management system.

The retrofitting of LED lights to replace legacy technologies such as incandescent, halogen & fluorescent light sources provides numerous benefits because of increased reliability, energy efficiency, and the ability to couple the LEDs to a network. For instance, networked lights can enable reduced energy consumption via dimming of lights in response to a utility-generated command external to a building, delivered via the “Cloud,” i.e., via the building's network. Such networking also enables building administrators to more easily control building lighting and establish more intelligent triggers and automated functions to control lighting. Retrofitting lights also allows the retrofitting of devices such as switches and outlets with networked equivalents. Further, other networked devices such as motion sensors, thermostats, and humidity sensors, to name a few, can be added during the retrofit.

However, such networking also complicates the installation process as lights and other networked devices must be identified, added to the network, and configured into groups and assigned triggers and automated functions. For instance, the automated functions may include priorities that can be assigned to the groups of devices. More particularly, an office building may dim hall lights before it dims those of conference rooms and offices, or it may dim the lights of a conference room that is unoccupied before one that is occupied. Adding lights and other devices to the network, grouping them, and then assigning protocols and triggers to control these groups can be a challenging and labor-intensive process, especially where buildings can include thousands of lights and other networked devices and hundreds of groupings.

For the purposes of this disclosure, the process of adding lights and other devices to a network and associating each device to a human-readable identification that allows it to be addressed will be referred to as “registration.” The process of grouping lights and other networked devices and assigning triggers and automated functions to individual lights devices and groups of lights and devices will be referred to as “configuration”. The entire process of registration and configuration will be referred to as “commissioning.”

Often an LED retrofit project also requires an audit of the existing lighting within the building. Typical audits involve an individual walking through a building room-by-room, noting the type and style of light fixtures and noting the replacement parts that will be needed for each fixture. The location (e.g., room number) will be noted along with the items needed in that room. The assembled data, perhaps consisting of hundreds or thousands of lights is then used to calculate a cost of the project and order parts (if the proposal is successful), and the layout is saved either on paper or other format which then serves as a guide to the subsequent installation.

The next steps are to electrically install and commission the lights and other networked devices. If simply connecting the light to power was all that was required, it would be simple enough. However, commissioning of networked devices greatly increases the complexity of commissioning. Thus, the herein disclosed commissioning systems and methods greatly ease the challenges and scalability of commissioning networked devices. Once a registration portion of commissioning is complete, the central application can configure the networked devices by collecting data and/or configuring lights and/or devices to respond appropriately to local sensors and other triggers. For example, lights can be configured to dim or brighten based on the occupancy level of the room, time of day, and/or other factors. As another example, the central application may be configured to group a first device with a second device, the grouping responsive to determining that the first device and the second device are at least one of in the same room, in the same service system, or of the same type. The phrase “in the same service system” is to be understood to mean a logical system of devices such as, but not limited to, devices in an office associated with devices in a hallway (e.g. triggering a hallway light may trigger an office light), a climate control in an office associated with a light in the office (e.g. a motion sensor in the office may trigger the light, and the light or motion sensor may trigger the climate control), etc.. Those skilled in the art will recognize that the central application may be distributed across one or more hardware components, software components, or firmware components. For example, a portion of the central application may reside in a control fob, and another portion of the central application may reside in a cloud service or storage.

Wirelessly networked devices are particularly appealing in retrofit applications because wireless communications preclude the need to add physical wiring to the building infrastructure. Re-wiring is time-consuming and expensive; in some applications, it is not even practicable. However, the registration step is particularly challenging for wirelessly networked devices. The point of registration is to associate a human-understandable identifier for each device with its unique wireless radio address. In one example, the human-understandable identifier might be a description and physical location of a light, such as “the downlight in the north-west corner of room 203.” Once the human-understandable identifier has been associated with the wireless radio address, it is possible to configure and/or command the device by addressing wireless commands to the appropriate radio address. The registration step is necessary because otherwise there is no way to send commands to a specific light. Registration is difficult for wireless devices because there is no obvious way to associate physical lights with their radio address. Typically, after installation, it is possible to accumulate a list of all radio addresses by listening to all wireless transmissions that include the sender's wireless radio address in the transmission. With this list, one way to complete registration is to command a single light on the address list to blink. A human can then identify the blinking light and record a human-understandable identifier associated with the radio address for the blinking light. This process is used in the industry (for example, with PHILIPS HUE light system). Unfortunately, this process is slow and inefficient in large facilities where the blinking light is unlikely to be in the same room as the installer. Further, when complete, this process creates a large table of devices, and it is difficult to use this table for the configuration process.

One preferred commissioning system would be fast and simple to use so that it could be used by an agent with minimal training. Further, the result of the commissioning process would be a visual representation of the building that made it easy to identify and select lights and/or devices. To command or configure a device, it would be simple to navigate through the virtual representation of the building and select the device. The most obvious way to do this is with a map or collection of photographs (2D solutions). It would be even better if the solution provided a 3-dimensional (3D) rendering of the building with the locations of each device built into the rendering thus allowing users to virtually move through the building and easily ‘look’ at ceilings, walls and floors. Today, most commissioning systems instead provide a large table listing each device together with its location in the building—this list forces users to navigate through menus and lists to select and group devices.

Prior art systems have attempted the registration process by using a wand held in proximity to newly-retrofitted lights to identify the lights and add them to the network. When the installer signals a light using the wand, the light sends out an identifying transmission. Wands commonly use signaling technologies with limited range that are direction-specific, such as infra-red, to signal to the light, so that they are heard by a single light. Because the signaling is directional, it is often only received by the intended device. Once the device receives the signal, it sends out a wireless transmission with its unique network address. The installer can then record location and/or other identifying information to associate with the network address of the device. In this way, the problem identified above (that the activated light might not be in the same location as the installer) is resolved. However, there are a number of problems with the wand approach. First, it requires physically interacting with every light in the facility which can be slow and cumbersome. Second, the wand approach requires adding a sensor to each device that detects the wand's activation signal (typically an IR light sensor). This sensor adds cost and may not be aesthetically desirable.

In some implementations, GPS sensors in a handheld device have been used to aid in traditional forms of commissioning. However, the use of GPS has been hampered by its inaccuracy within buildings, and thus more detailed light locations have to be roughly recorded by hand. For instance, room number can indicate the location of a grouping of lights, but more detailed locations are often beyond recordation due to time constraints and lack of accurate measurement means. While this is adequate for small projects, such as small homes, it does not aide in the commissioning of networked lights and sensors that must be organized and located with respect to floor and room plans in larger buildings involving hundreds or thousands of devices.

Another problem with the wand approach to commissioning is that a human commissioning agent can sometimes miss lights. For instance, they may fail to see a light that is hidden behind an architectural feature or one that is not turned on. Additionally, where no map is created, grouping those lights, assigning triggers, and assigning automated functions can be challenging. Even with 2D maps, while lights on ceilings can be easily distinguished, sconces and other wall-mounted lights are not so easily separated when viewed from above on a 2D map. Further, the 2D view provides little context regarding a room and thus makes it more challenging to program triggers and automated functions that fit the needs of a given room. For example, a photograph of a ceiling of lights is not a familiar view for building occupants even though it is the easiest way to capture the most lights in a single image. There is therefore a need in the art for more effective, easy-to-use, and scalable commissioning technologies.

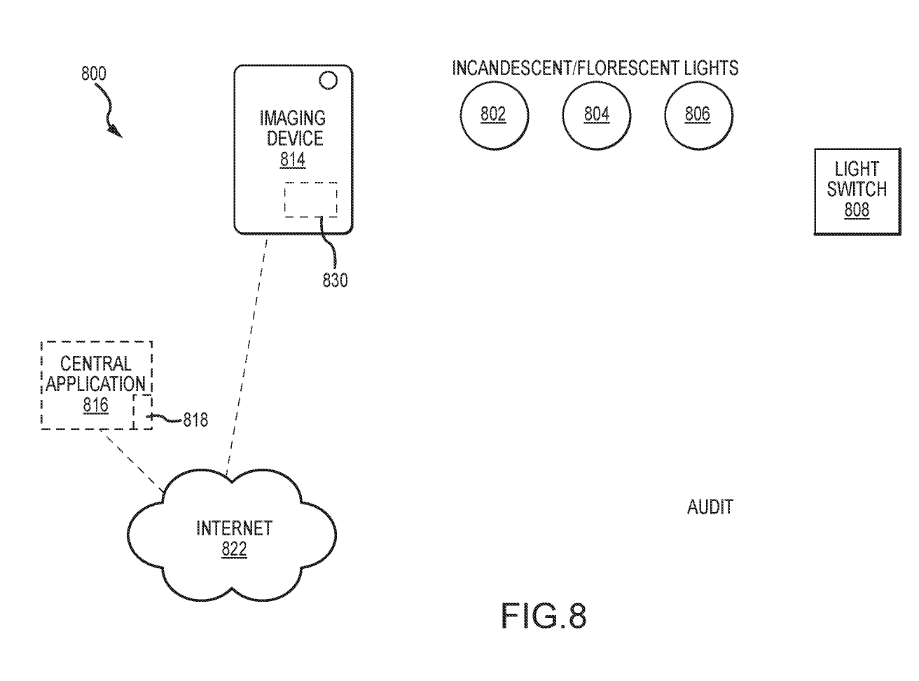

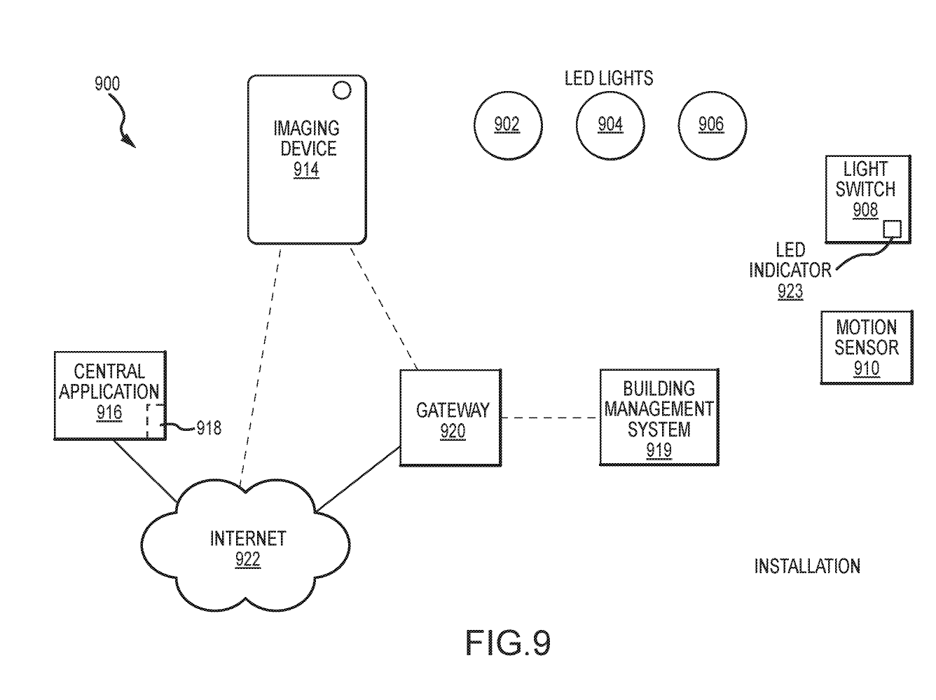

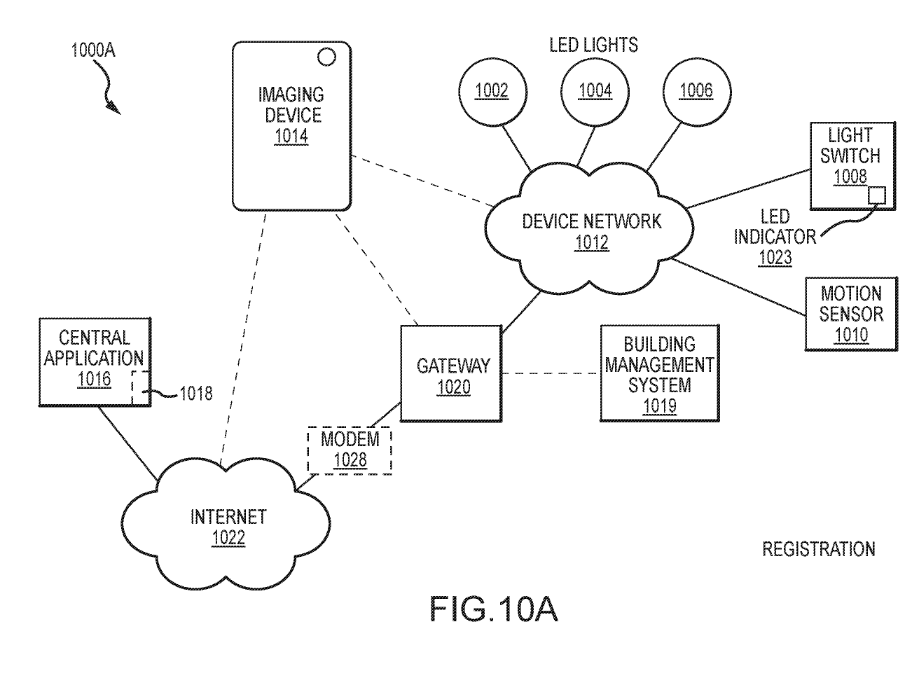

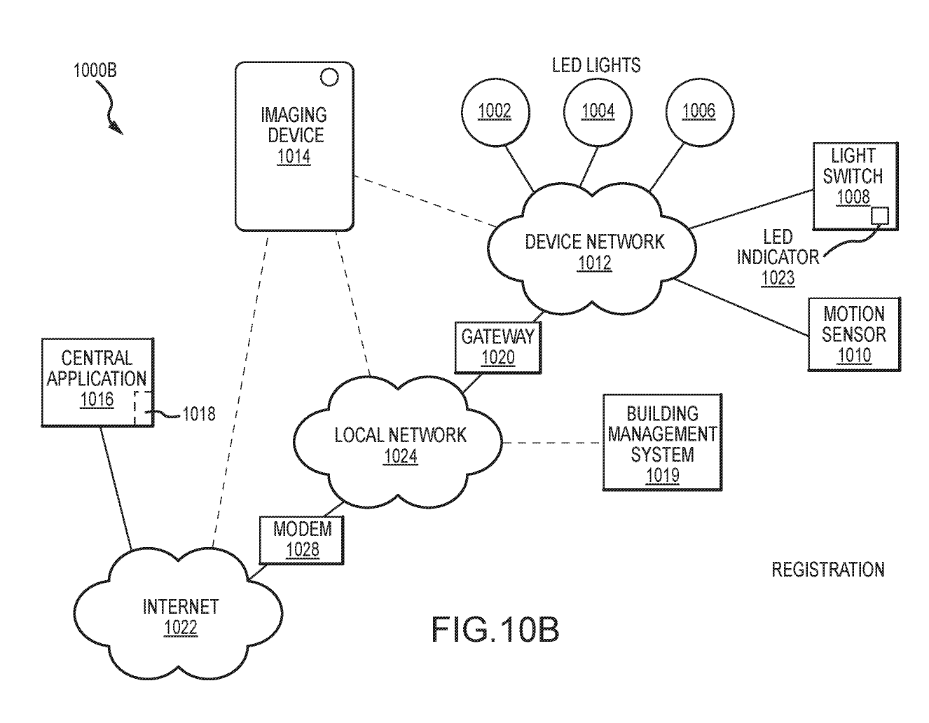

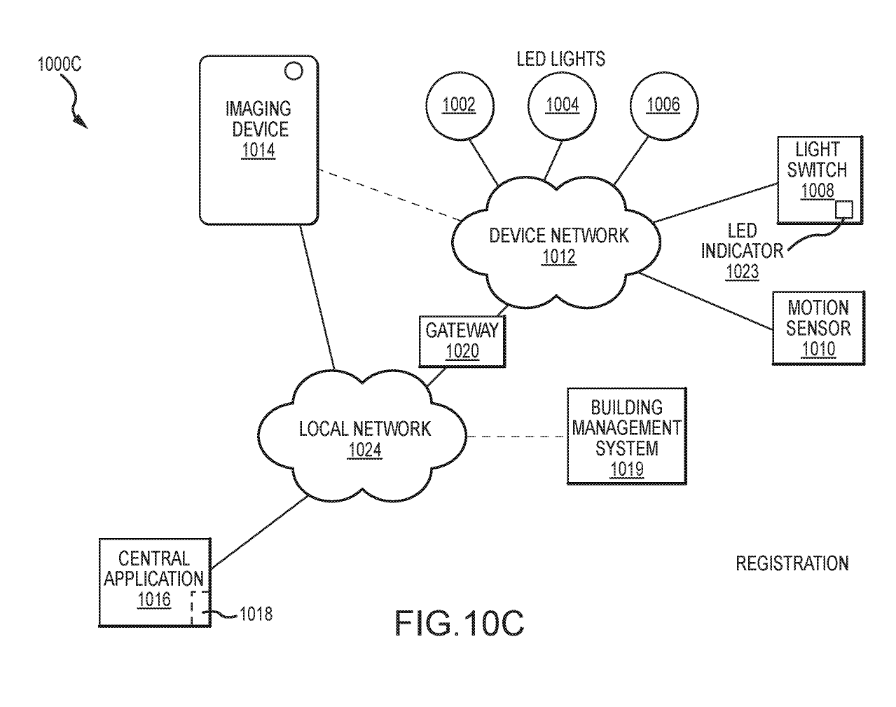

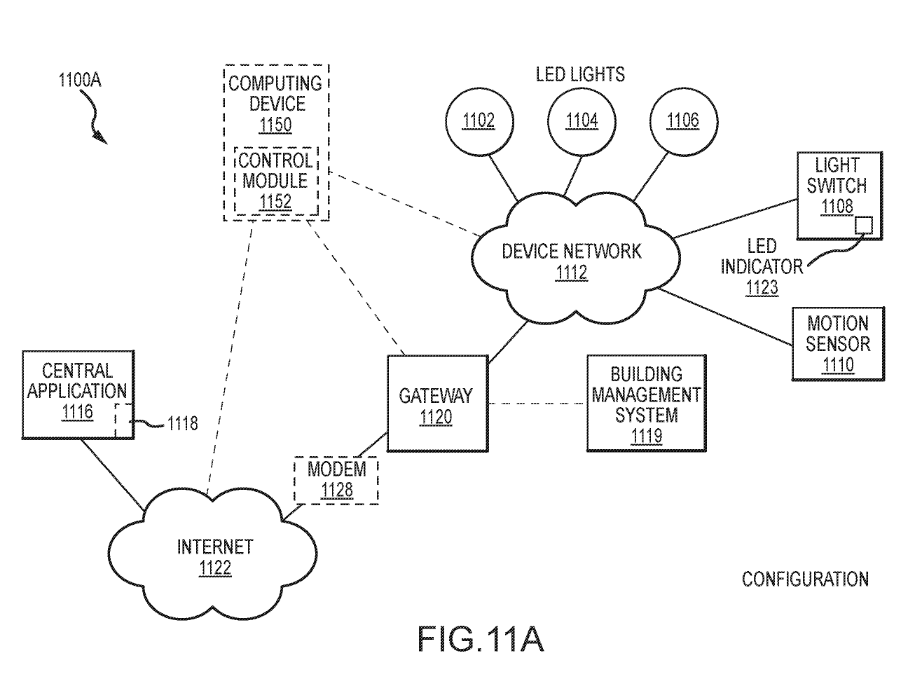

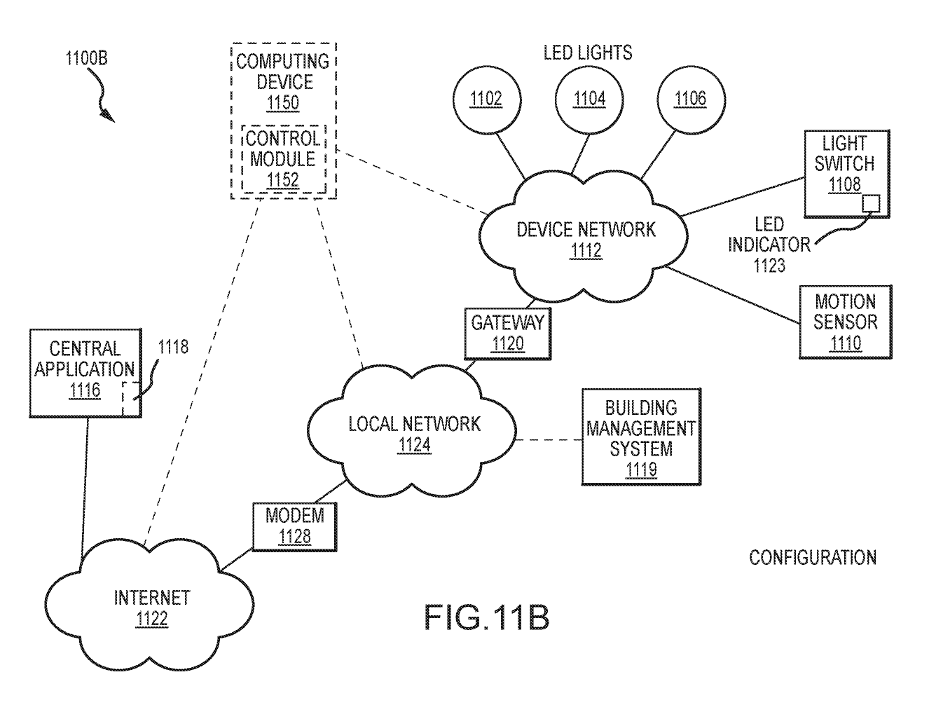

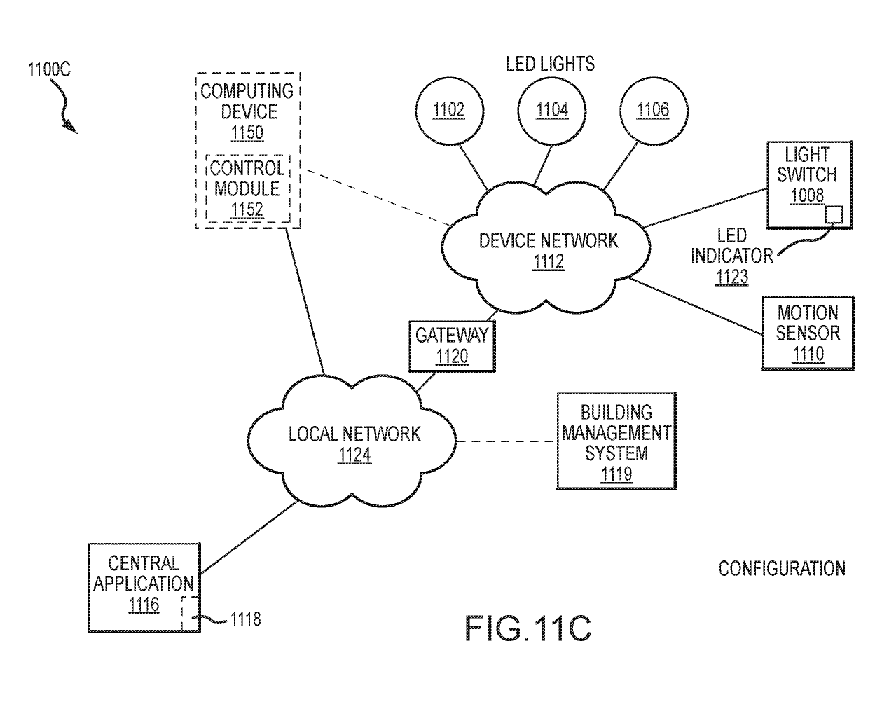

The present disclosure solves the above-noted problems by commissioning lights and other networked devices within buildings via registration and configuration operations, and optionally also with the addition of an audit process and installation process before the registration and/or an optional tracking operation after the configuration operation. In particular, the commissioning can involve five stages: (1) an optional audit of the existing lighting and other devices (see FIG. 8); (2) optional installation of the lights and other devices (see FIG. 9); (3) registration of the retrofitted lights and other networked devices (see FIGS. 10A-10C); (4) configuration of the retrofitted lights and any other networked lights or devices (see FIGS. 11A-11C); and (5) optional tracking of persons and objects within the building using the newly-commissioned lights (not illustrated). Additionally, once commissioning (e.g., registration and configuration) is complete, a building administrator can control the lights and other networked devices via a web application or other application running on a local network. While this disclosure largely focuses on the commissioning of lights, many of the herein disclosed embodiments can be implemented using devices other than lights that have radios (e.g., light switches, thermostats, networked HVAC vents, computers, TVs, motion sensors, moisture sensors, etc.). For instance, the herein disclosed embodiments can be implemented via (1) lights, (2) lights and non-light devices (e.g., switches, motion sensors, thermostats), or (3) non-light devices. In other words, the herein disclosed embodiments can apply to networked lights as well as networked devices.

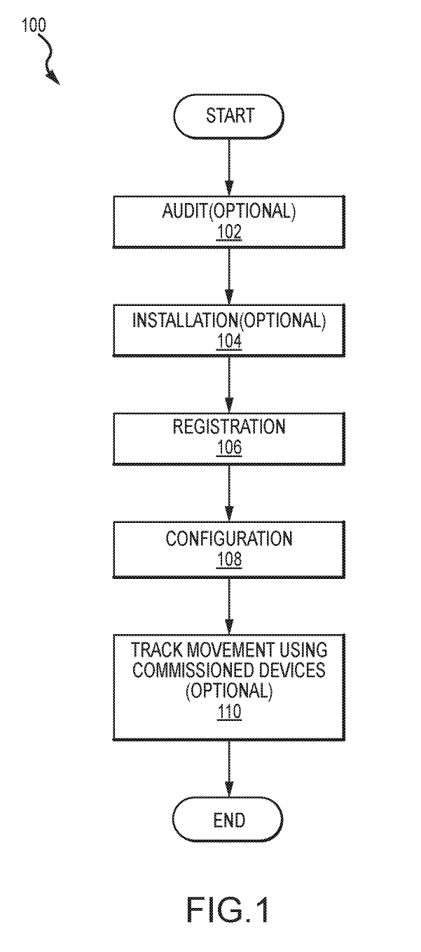

FIG. 1 illustrates one embodiment of a method 100 for retrofitting a lighting system, and this method 100 will be discussed in conjunction with FIGS. 8-11C describing embodiments of systems for implementing the method 100. The method 100 includes five stages, three of which are optional. In an optional audit 102 the building can be audited to determine what lights and other devices need to be replaced and determine what, if any, additional devices need to be installed (see FIG. 8). In some cases, the audit 102 can also include using an optional imaging device 822 in communication with a central application 820 to generate a 2D schematic or 3D model of the building that can include locations of lights 802, 804, 806 and other devices 808 needing replacement. After the audit 102, lights and devices can be replaced and installed in the installation 104 operation (see FIG. 9). For instance, in FIG. 9, LED lights 902, 904, 906 have replaced the incandescent or florescent lights 802, 804, 806 of FIG. 8. The installation 104 also included the addition of a new motion sensor 910 that did not exist during the audit 102.

After installation 104, the retrofitted lights and other devices can be registered with a central application in registration 106 (see FIGS. 10A-10C). In particular, registration 106 can include adding the retrofitted lights 1002, 1004, 1006 and other retrofitted or new devices 1008, 1010 to a device network 1012 and associating locations of the devices 1002, 1004, 1006, 1008, 1010 with human-understandable identifiers and network addresses for each device 1002, 1004, 1006, 1008, 1010. This registration 106 can be performed via an imaging device 1014 in communication with a central application 1016, and the locations, human-understandable identifiers, and network addresses can be stored in a database 1018 that may reside in the central application 1016. The registration 106 can involve the imaging device 1014 (which may or may not be the same imaging device 822 used in the audit 102) creating a 2D schematic or 3D model of the building while registering the lights 1002, 1004, 1006, and other networked devices 1008, 1010, or can involve the imaging device 1014 updating a 2D schematic or 3D model generated in the audit 102. Different system configurations (see FIGS. 10A, 10B, and 10C) will be described in detail below for three embodiments of systems that implement the registration 106.

Next, configuration 108 of the lights and other devices can be performed (see FIGS. 11A-11C). Configuration 108 can include grouping devices, assigning triggers and creating automated functions for groupings of devices or individual devices (e.g., triggering lights to turn on when someone enters a room). The configuration 108 can be performed via a control module 852 of an optional computing device 1150 that may or may not be the imagining device 1014 from the registration 106. Alternatively, the configuration 108 can be performed via a building management system 1119 or a control module (not illustrated) residing on the building management system 1119. Different system configurations (see FIGS. 11A, 11B, and 11C) will be described in detail below for three embodiments of systems that implement the configuration 108.

The final operation is an optional tracking 110 operation. Tracking 110 uses the known locations of the devices registered in registration 106 along with wireless triangulation of devices being carried by people or coupled to objects to determine and track the locations of people and objects in the building. Although not shown, the system implementation of the optional tracking 110 will be similar to that shown in FIGS. 11A-11C. In addition to tracking 110, once the commissioning (106, 108) is complete, a system administrator can control the lights and other networked devices via a web-based application (e.g., the central application 1116 residing on a web-based server as shown in FIGS. 11A and 11B), an application on a local area network (e.g., the central application 116 residing on a local area network server as shown in FIG. 11C), or via a control module on the building management system 1119.

Audit 102

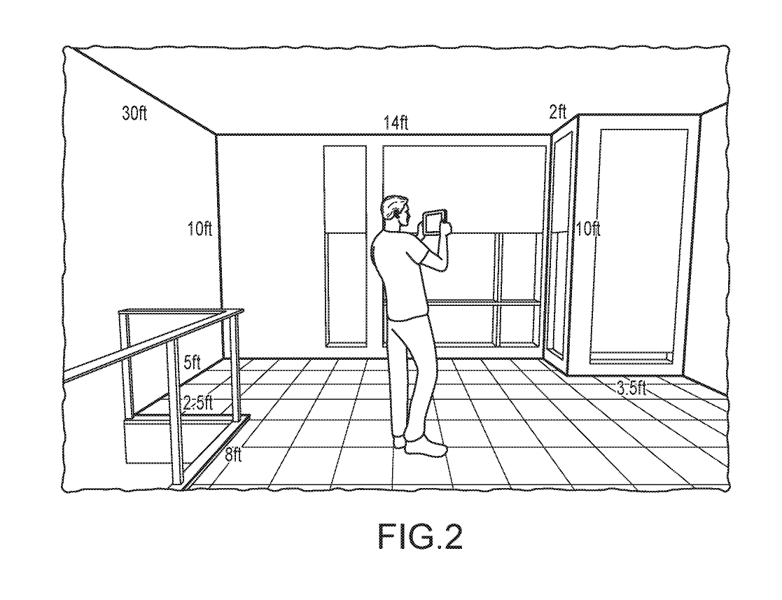

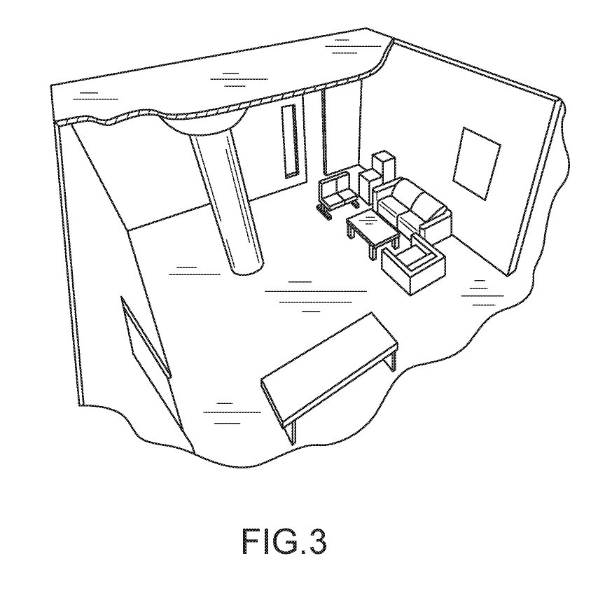

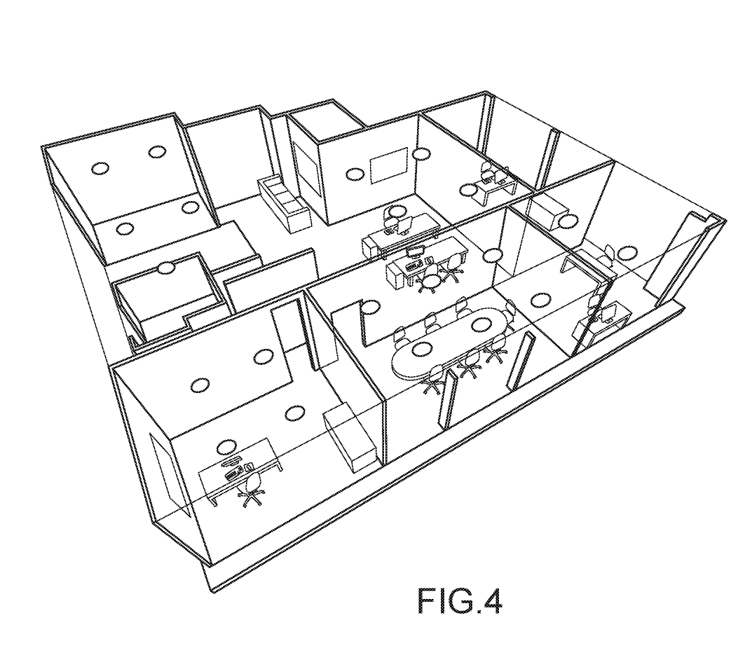

The audit 102 can include using an imaging device 814 and recording images showing locations of lights 802, 804, 806 and other devices 808 that are to be retrofitted. In one embodiment, the imaging device 814 can move around the building and take field measurements and/or photos and/or videos that can be used to create a 2D schematic or 3D model of the building including locations of the devices 802, 804, 806, 808. FIG. 2 shows a visualization of an imaging device (e.g., an iPad coupled to an OCCIPITAL STRUCTURE sensor) forming a 3D model, including measurements, of an interior of a home. Many buildings these days are old enough that schematics and maps of the building no longer exist or have been lost. Thus, creating such maps, schematics, and/or 3D models is an added benefit beyond the retrofitting of lights and other devices that the herein disclosed systems, methods, and apparatus make possible. The audit 102 may also involve locating lights, fixtures, and other electrical devices within the 2D schematic or 3D model. FIG. 4 illustrates a 3D model of a section of a floor of an office building along with the locations of recessed lights in the ceilings. FIGS. 3 and 4 show renderings of a 3D model generated with a MATTERPORT Pro 3D Camera. These 3D models can be rotated and viewed from any angle, and they show not just building structure (e.g., walls, columns, doors), but also objects and fixtures (e.g., desks, chairs, computer monitors, lighting fixtures, artwork, and printers).

Some or all of the lights 802, 804, 806 an devices 808 can be replaced in the retrofit and having an accurate location of each light or other device in the 2D schematic or 3D model can improve the efficiency of the retrofit.

While 3D capture can provide accurate locations of structure and objects within a room, it is sometimes difficult to locate rooms within a building floorplan. For instance, capture may not take place between rooms, on elevators, in certain hallways, or on stairwells, making it difficult to piece together isolated rooms in an overall building model. Wireless triangulation methods and/or magnetic field measurements could be used to arrange different room captures relative to each other, even allowing one to create a floorplan. These absolute or relative locations of the devices 802, 804, 806, 808 and/or different segments of the 2D schematic or 3D model can be generated through the use of geospatial components of the imaging device 814. Geospatial components can include wireless triangulation circuitry, GPS circuitry, magnetic field vector circuitry, an accelerometer, and a gyroscope, to name a few non-limiting examples. Additionally, an image analysis module can analyze the images taken by the imaging device and determine locations of rooms, building structure, and devices. Geospatial components and image analysis can be used in combination to produce even more accurate 2D schematics, 3D models, and/or device locations.

Wireless triangulation, wireless ranging, magnetic field measurements, geospatial components of the imaging device 814, and image analysis can be used either alone or in combination to determine a location of the imaging device 814 and the location of lights 802, 804, 806, and other devices 808 relative to the imaging device 814. Alternatively, one or more of these technologies, alone or in combination, can be used to determine locations of the lights 802, 804, 806, and other devices 808 independent of the imaging device 814.

The audit 102 can include selecting device types and specific devices to replace the existing devices 802, 804, 806, 808. In some cases, the audit 102 can include determining what and where new devices are to be located (e.g., a motion sensor). For instance, some rooms may have inadequate light, and thus one or more new surface mount or recessed lighting fixtures and switches may be recommended during the audit 102.

The audit 102 may generate a list or database of lights and other devices that need replacing, and possibly a list of new lights and devices that need to be installed. The items in the audit list can be associated with a location in the 2D schematic or 3D model. Such a list or database can be stored as part of the central application 816 on a remote cloud server. The list or database can alternatively be stored in a memory 830 of the imaging device 814.

Analysis of data to determine locations can be performed via one or more processors of the imaging device 814 or can be remotely performed via processors on a remote or local server. For instance, an optional central application 820 residing on a remote server on the Internet 814 can perform this analysis. The data can be stored on a memory 830 on the imaging device 814 or on the optional central application 816.

The imaging device 814 can be any portable computing device including, but not limited to, a tablet computer (e.g., IPAD), a cellular phone (e.g., SAMSUNG GALAXY S6), or a camera (e.g., NIKON D7000). The imaging device 814 can use multiple cameras or other stereoscopic sensors (e.g., OCCIPITAL, MATTERPORT) or a single camera (e.g., INSIDE MAPS).

In some embodiments, the audit 102 can include identification and locating of energy-consuming objects and fixtures. For instance, visual scanning of a room to create a 3D model can include image analysis algorithms that identify refrigerators, TVs, computers, dishwashing machines, ceiling fans, portable heaters, etc. based on analyses of object and fixture shapes, movement of the objects or fixtures (e.g., the spinning of a fan), thermal signatures (where the imaging device includes a thermal camera), and/or location (e.g., an object located near an electrical outlet is more likely to be plugged into the grid and drawing electricity). This aspect of the audit 102 could be useful to help create or supplement a database with energy-consuming devices other than fixed lighting that is normally detected in the audit 102. While the identities and locations of these additional energy-consuming devices may not be used in the remainder of the commissioning process, the information can be useful for building management and utilities, and the ability to collect this information incidentally to an audit 102 that has to be performed anyway, is a major benefit of the herein disclosed systems, methods, and apparatus.

In some embodiments, the audit 102 can include analyzing the distribution of light (e.g., a light intensity map) to determine ideal types of lights, brightness, color, and beam spread to use in the retrofit. For instance, such an analysis may automatically determine that a set of four recessed lights in an office is causing an unwanted area of shadow on the walls and corners of the rooms, and therefore a recommendation to retrofit the room using LED lights with a broader beam spread could be made. The analysis can weigh energy consumption versus light output and attempt to optimize a room's brightness while suggesting lights that minimize energy consumption. For instance, retrofit of a room with four 75W-equivalent LED lights that actually consume 13.5W of energy may be deemed too much light in an office that also has two sides of south-facing windows and hence plenty of natural light. While the recommendation for interior offices without such windows may include four 75W-equivalent LED lights, the recommendation for this sun-bathed room may include four 50W-equivalent LED lights consuming 5W. Alternatively, the audit 102 may recognize the need for equivalent lighting throughout the building during nighttime hours, and therefore may recommend 75W-equivalent LED lights for all offices, regardless of natural light, but recommend a lower daytime dimmed setting for those offices that receive more natural light. These are just a few non-limiting examples to show the plethora of analyses that the audit 102 can perform beyond merely determination of building structure and locations of devices to be replaced.

Registration 106

Registration 106 can include adding lights and other networked devices to a device network 1012 and locating the lights and other networked devices. Adding the devices to a device network can be performed via logic on an imaging device 1014 or via a central application 1016 in the cloud (e.g., residing on servers coupled to the Internet 1022). Registration can begin with the lights 1002, 1004, 1006 generating a visual indicator that represents a network address for a given one of the lights 1002, 1004, 1006. For instance, dimming or flashing can be performed either when each light is first powered on after installation or when a remote signal instructs the light to enter an identification mode. In some embodiments, the flashing can be performed so rapidly (e.g., have such a high frequency) as to be imperceptible to the human eye. The imaging device 1014 can scan an interior of the building and observe the flashing or other visual indicators from the lights 1002, 1004, 1006 and record the corresponding network address for each light along with a location of each light. Scanning can be performed by manually moving the imaging device 1014 around a structure, affixing it to a backpack, or carrying out an automated scanning by affixing the imaging device 1014 to a drone or robot. If a remote signal triggers the flashing or other visual indicator, the signal can be generated by the imaging device 1014, the central application 1016, or a gateway 1020. For instance, the imaging device 1014 can broadcast a signal or instruction to all networked devices in a room telling them to identify themselves, and in response, each device can broadcast an optical or RF signal representing a unique identifier or radio identification of the device.

This same scheme of determining a device network address from a unique pattern of flashing in a light can be used with any device that has a light, even mere single LED indicator lights like those seen on many smart light switches. Even the flashing and rapid dimming of these small indicator lights can be picked up by the imaging device 1014 and used to identify these devices. Thus, registration 106 can be performed for both lights 1002, 1004, 1006 dedicated to illuminating spaces and other devices having at least one light not dedicated to illuminating spaces (e.g., the light switch 1008 with LED indicator 1023).

Additionally, the installer can record a human-understandable identifier for each device by associating the human-understandable identifier with the location on the 2D schematic or 3D model. The central application 1016 can then associate this information with the network address associated with the device in the 2D schematic or 3D model. Alternatively, the imaging device 1014 can automatically assign a human-understandable identifier to each device based on locations of the devices (e.g., ceiling troffer, wall sconce, ceiling downlights, etc.).

As noted above, registration 106 can also include building a 3D model, or updating a 3D model if one has already been generated during the audit 102. The 3D model can include locations of lights (e.g., 1002, 1004, 1006) and other networked devices (e.g., 1008, 1010). Such locations can later be used in the naming of devices and used to provide categorizations of devices to assist in the configuration 108. There is a significant advantage to creating a 2D image or 3D model of the building at the same time as registration 106 or during the audit 102 (for example, via the lights dimming/flashing to reveal their wireless address). First, by combining the processes, commissioning can be completed more quickly. Second, the radio addresses can be associated with specific locations on the 2D schematic or 3D model. Then, during the configuration 108, lights can be identified and selected using the 2D schematic or 3D model that is more intuitive to work with than the prior art's table of devices.

The network address can be associated with a location on a simultaneously generated 2D schematic or 3D model that is created as the imaging device 1414 is moved around the structure. Alternatively, where the 2D schematic or 3D model is created in the audit 102, the network address can be associated with a location within the previously-created 2D schematic or 3D model, or with an updated 2D schematic or 3D model. The locations can be identified via image analysis, wireless triangulation, wireless ranging, or other methods that provide a location of a light or other networked device relative to the imaging device 1014. In other embodiments, the lights or other networked devices, or the gateway 1020, can use wireless triangulation, wireless ranging, BLE, or other methods to determine a location of a device without the help of the imaging device 1014.

Wireless triangulation, wireless ranging, BLE, and other methods can be used alone or in combination. In one embodiment, angle-sensitive antennas (e.g., phase-sensitive antenna, phase-array antenna, beam-forming antenna) can be used to improve an accuracy of wireless location determinations. Angle-sensitive antennas can be used with any wireless protocol including BLUETOOTH, WIFI, ZIGBEE, and Z-WAVE, to name just a few non-limiting examples. The multiple antennas or phase array of antennas can be used to accurately locate the other wireless device in the pair. Other geospatial components such as GPS circuitry, magnetic field vector circuitry, an accelerometer, and a gyroscope, to name a few non-limiting examples, can be used to locate the imaging device 1014. Additionally, locations of the imaging device 1014 can be derived from inertial measurements from a cellular phone, tablet computer, or other computing devices, in combination with RF signals via such techniques as triangulation.

Once the location of the imaging device 1014 is known, locations of the devices can be determined. In some cases, the locations of the devices relative to the imaging device 1014 can be derived via image analysis of image data from the imaging device 1014. Wireless ranging based on a signal strength of a signal from the networked devices 1002, 1004, 1006, 1008, 1010 received by the imaging device 1014 can also be used to determine device location relative to the imaging device 1014. Further, once a location of a networked device 1002, 1004, 1006, 1008, 1010 has been determined, then this device can begin relaying received wireless signals from networked devices 1002, 1004, 1006, 1008, 1010 whose locations are not yet known, and this information can be used in combination with other triangulation and signal strength measurements to enhance the accuracy of those methods. For instance, a location of the imaging device 1014, a location of a gateway, and a location of a first networked light in an office can be known. The imaging device 1014, the gateway, and the first networked light can all act as wireless receivers and pass signal strength and phase information to a processor for performing triangulation and/or wireless ranging of a second networked light in the room that is transmitting a known signal. Once the location of this second networked light is determined, it too can act as a wireless receiver and add received data to that being processed to determine locations of additional networked lights. At the same time, as each new networked device becomes registered and its location is determined, these newly registered devices can also receive signals from previously-registered devices and thereby improve an accuracy of the determined location for previously-registered devices. In this way, as more and more devices are registered and added to the device network 1012, the accuracy of location information for previously-registered devices improves, and the accuracy of determining a location for new devices improves. Further, the accuracy of location information improves with a greater density of devices and larger numbers of devices in a building.

Those skilled in the art will recognize that the devices may include any combination of a first retrofitted light source, a second retrofitted light source, a motion sensor, a light switch, a thermostat, a networked HVAC vent, a computer, a television, a moisture sensor, a light sensor, a door sensor, a window sensor, a decibel meter, or a hotel key card switch

While GPS is often not usable indoors, several other methods have been developed for accurate indoor location mapping. For instance, variations in the earth's magnetic field occur indoors as a result of a building's construction materials, and a map of the geomagnetic magnetic field within a building can serve as a baseline for a “map” within the building. The dipole vectors can form a unique “fingerprint” allowing for location accuracies of 1-2 meters. Organizations such as Indoor Atlas (www.indooratlas.com) are developing variations of this technology.

Another technology for indoor mapping uses RF signals which can be WIFI (for longer distances, 10-100 Meters) or BLUETOOTH Low Energy (BLE) (for shorter distances 1-10 Meters). By measuring the signal intensity from at least 3 locations within the building and/or measuring response times from “pings” to and from the RF location points, algorithms can determine the location of a transceiver within the building. Tablets or cell phones, and networked fixtures with internal wireless radios (e.g., ZIGBEE or Z-WAVE light switches) are just a few examples of such transceivers. Several organizations are involved in developing RF indoor locating technologies. For instance, GISI uses a combination of BLE, WIFI and the proprietary IBEACON appliances to map locations indoors with high accuracy, usually to within 1-2 meters. The above-noted technologies can be used to create the 2D schematics and 3D models either in the registration 106, the audit 102, or in the audit 102 with update in the registration 106.

Another method for indoor locating that can be used in combination with those mentioned above, or alone, is triangulation and ranging based on RFID tags. Here a signal, usually RF, but sometimes audio or light, is used to modulate the frequency of an ambient signal received by the RFID tag and rebroadcast as an identifying code that can be detected by the imaging device 1014. Thus, an RFID transceiver is another geospatial component that the imaging device 1014 can include. This method is especially attractive because of its low cost, but has limited range compared to other technologies such as WIFI triangulation. RFID tags have been used for various forms of indoor tracking, most notably, customer tracking in retail spaces. RFID tags can be included in lights and other networked devices that are installed in the building and then corresponding RFID identifications and RFID signal strengths can be used to locate devices within the 2D schematic or 3D model. An RFID detector or transceiver can be integral with or affixed to the imaging device 1014. Also, an RFID detector or transceiver can be affixed to the structure, for instance in doorways.

RFID tags can provide a location of a networked device with an accuracy down to 0.5 meters and even 0.02 meters. These RFID tags can be active or passive. In one embodiment, RFID locating can use an angle-sensitive antenna (e.g., phase-sensitive antenna, phase-array antenna, beam-forming antenna).

In an embodiment, networked devices with lights (e.g., light switch 1008) can also include an RFID tag, and thereby provide two different ways to indicate their network address (i.e., via optical or RF signals). This may be advantageous where a light or other networked device is not detected by the camera(s) of the imaging device 1014 (e.g., obscured by an architectural feature or missed via human error), but is detected and identified via the RFID signal. In other words, an orientation of the imaging device may miss one or more lighting devices, but their signatures can still be obtained through the RFID signal. RFID indicators may also be used to identify lights that do not have radios.

RFID tags can be affixed to the lights or other networked devices themselves, or to a fixture in which a light is installed (e.g., a recessed light housing). Barcodes can also be included on lights or other networked devices, or their housing, in addition to or as an alternative to the RFID tags. Both RFID tags and barcodes allow the light's network address to be accessed even after installation. Near Field (wireless) Communication is another means for wirelessly identifying a network address of lights and other networked devices, but this may require that electrical power be provided to the lights.

Where a barcode is used, the barcodes or other identifier has a unique code that distinguishes it from other items in the building. A handheld scanner, or the imaging device 1014, can scan the barcode and pass the fixture's network address to the central application 1016. In this scenario the barcodes or other identifier simply has a unique code that distinguishes it from other items in the building. A handheld scanner is then connected to the gateway 1020 thru a wired or preferably a wireless connection. When energized, the light broadcasts its identifier which uniquely associated with the fixture. The gateway 1020 assigns the fixture an address on the network. The handheld scanner equipped with at least a keypad is then prompted by the gateway 1020 to enter the room number or other location identifier. The user then scans the light to associate the room identifier with the light so the network address, Room Number and identification code can be added to a database residing on the gateway 1020 or the central application 1016 and the light can subsequently be controlled. In this case the actual physical location is unknown except by inference, and the additional functionality of tracking other objects is missing.

Said another way, a user can scan a device's barcode with a scanning device or scanning application of a cellular phone, tablet computer, or other mobile computing device. The scanned barcode is then sent to the gateway 1020 or central application 1016. The gateway 1020 or central application 1016 then prompts the user to enter a room number or other human-understandable identifier of the device. The user then pushes a button on the device that instructs the device to output an identifying signal (e.g., optical or RF). The gateway 1020 or central application 1016 receives this identifying signal and associates a network address with the device and the human-understandable identifier.

The gateway 1020 is primarily responsible for relaying messages between the device network 1012 and the central application 1016. Specifically, it can listen for transmissions from the devices 1002, 1004, 1006, 1008, 1010 (e.g., an ENOCEAN, Z-WAVE, etc. transmission), record these transmissions, and upload the relevant data to the central application 1016 through the Internet 1022. Also, when the central application 1016 needs to send a command to a device 1002, 1004, 1006, 1008, 1010, it sends the message and intended recipient network address to the gateway 1020; the gateway 1020 than sends out the appropriate transmission (e.g., ENOCEAN, Z-WAVE, etc.) so that it will be heard by the device 1002, 1004, 1006, 1008, 1010.

The gateway 1020 can also provide some other functions. For example, it can include a real-time clock that it updates occasionally using an Internet 1022 time server. The gateway 1020 can routinely send out device transmissions with the current time. Devices that don't have real-time clocks can hear these transmissions and update their internal clocks appropriately so that scheduled events happen at the appropriate time. Multiple gateways 1020 can be used when the range of the radio of a single gateway 1020 is not adequate to cover an entire building.

FIGS. 10A-10C show three different embodiments of systems configured to register retrofitted lights and other devices. FIG. 10A shows a system 1000A where various networked devices 1002, 1004, 1006, 1008, 1010 are part of a device network 1012 (e.g., ENOCEAN) such as a mesh network (e.g., Z-WAVE OR ZIGBEE). However, the device network 1012 can comprise other than a mesh network. A list or database 1018 of device 1002, 1004, 1006, 1008, 1010 network addresses, locations, and human-understandable identifiers can optionally be stored on a web-based central application 1016 that resides on a remote server accessible via the Internet 1022. A gateway 1020 can interface the device network 1012 and the Internet 1022. The gateway 1020 can include functionality of a wireless access points, a router, and a modem to name a few non-limiting examples, and can comprise any one or more of these functionalities in a single hardware device or distributed among multiple hardware devices. In an embodiment, an optional modem 1028 can interface the gateway 1020 to the Internet 1022. An optional building management system 1019 can be in communication with the gateway 1020, and thereby can optionally have access to and control over devices 1002, 1004, 1006, 1008, 1010 on the device network 1012. The imaging device 1014 can perform the registration 106 and optionally be connected to one or more of the device network 1012, the gateway 1020, and the central application 1016 through the Internet 1022. The imaging device 1014 can also provide an interface for performing registration 106 and configuration 108. While FIG. 10A only shows a single gateway 1020, in other embodiments, multiple gateway 1020 can be implemented. In an embodiment, the imaging device 1014, through the central application 1016, the gateway 1020, or the building management system 1019, can instruct certain of the devices 1002, 1004, 1006, 1008, 1010 to display or signal their unique identifier (optical or RF) as part of registration 106. For instance, the imaging device 1014 may instruct all devices 1002, 1004, 1006, 1008, 1010 coupled to a given gateway 1020 or within a certain distance of the imaging device 1014 to display or signal their unique identifier as part of registration 106.

FIG. 10B illustrates an embodiment of a system 1000B similar to 1000A, but now including a local area network 1024. The gateway 1020 interfaces between the device network 1012 and the local area network 1024. A modem 1028 interfaces the local network 1024 to the Internet 1022. The central application 1016 is again remotely arranged on a server accessible via the Internet 1022. The imaging device can optionally communicate with the network devices 1002, 1004, 1006, 1008, 1010, once they are registered, through the device network 1012 or the local network 1024. The imaging device 1014 can also optionally communicate with the central application 1016 via the local network 1024 of the Internet 1022.

In FIG. 10C, the central application 1016 is hosted on the local area network 1024. In this embodiment, the device network 1012 and the local area network 1024 can again interface via gateway 1020. The imaging device 1014 can be in communication with the central application 1016 via the local network 1024. Optionally, the imaging device 1014 can also be in communication with the networked devices 1002, 1004, 1006, 1008, 1010 via the device network 1012.

While the lights 1002, 1004, 1006 can include firmware, hardware, or a combination thereof that enables them to output an optical identification of their network address (e.g., flickering or dimming at a frequency), other networked devices 1008, 1010 may need other means to provide an identifying signal to the imaging device 1014. For instance, the illustrated light switch 1008, 1108 includes an LED indicator 1023 such as those seen on many ZIGBEE and Z-WAVE light switches in use today that indicates the on/off state of lights associated with the light switch 1008, 1108. This LED indicator 1023 while putting out far fewer lumens than a typical light (e.g., 1002, 1004, 1006), may still be programmed to modulate its light output so as to provide a similar unique identifying signal that the imaging device 1014 can observe and use to identify the light switch 1008.

Other networked devices may not have any type of light (e.g., motion sensor 1010) and thus may not be able to provide an identification that one or more cameras of the imaging device 1014 can observe. Instead, such devices can provide a wireless or RF identification that a wireless or RF receiver in the imaging device 1014 can detect and use to identify these devices. Similarly, an RFID tag in these networked devices can be used to wirelessly identify the device. For instance, the motion sensor 1010 or other networked device could include a button that commands the motion sensor 1010 to broadcast its identification and network address with a special wireless transmission that could be understood by the imaging device 1014. In this way, the imaging device 1014 can register all networked devices 1002, 1004, 1006, 1008, 1010 in the building whether a given device includes a high-output light, a low-output light, or no light.

In the systems described above physical locations of networked devices can be determined and mapped within 2D schematics or 3D models. However, another perhaps simpler registration 106 may also be considered, where only room assignments are required, rather than precise device locations, so that an association between rooms and lights and sensors can be made to create a database. This could allow control of networked devices in a given room without the need for specific device locations to be known.

In an embodiment, registration 106 can include lights 1002, 1004, 1006 and other networked devices 1008, 1010 locating themselves using any of a number of known technologies discussed herein, and transmitting this information to the gateway 1020 and/or the central application 1116. This would lead to a database 1018 of registered lights and other networked devices including locations and network addresses. Optionally, this database 1018 could be compared to the optional database 818 generated during the optional audit 102 to ensure that all lights 1002, 1004, 1006 and other networked devices 1008, 1010 are properly accounted for and their locations known. Any missing lights or other networked devices could be spotted and corrective measures taken.

Where location sensor and/or gateways were used in the audit 102 and removed thereafter, those sensors and/or gateways can be re-installed in their original locations during lighting and device installation 104 to ensure reproducibility.

In an embodiment, the gateway 1020 can include one or more GPS geospatial components. Similarly, any gateway 1020 having GPS functionality can be placed near an exterior of the building in order to enhance their ability to supplement location data with GPS data.

In some embodiments, lights 1002, 1004, 1006 and other networked devices 1008, 1010 that are installed during the retrofit, may include firmware, hardware, or a combination thereof enabling the device to output the unique identifying signal that the imaging device 1014 uses to identify those devices (e.g., a unique dimming/flickering pattern, a unique RFID signal, or a unique RF signal, to name a few non-limiting examples). Devices 1002, 1004, 1006, 1008, 1010 may begin emitting this identifying signal as soon as they are installed (e.g., as soon as they receive power), or may begin emitting this signal only when triggered by a signal from the imaging device 1014, gateway 1020, or building management system 1019 instructing the device 1002, 1004, 1006, 1008, 1010 to enter an identification mode. This identifying signal may be emitted for a finite period or until a termination signal or instruction is received.

For networked devices including a light (e.g., 1002, 1004, 1006, 1008) that can optically provide the aforementioned identifying signal (e.g., a flickering or dimming pattern), control of this activity can be via either control of a dimming line to an LED driver or an AC power line to the LED driver.

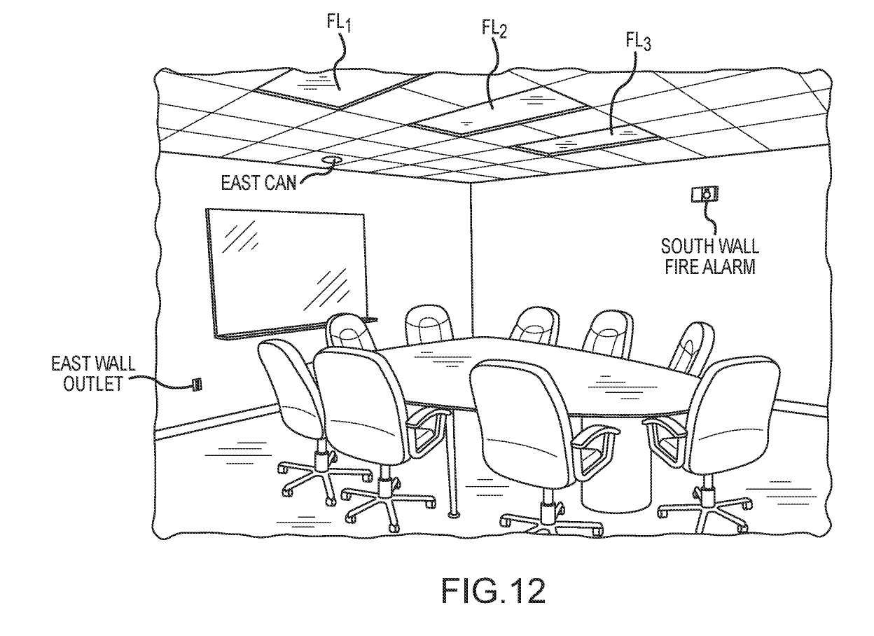

Registration 106 can also include naming networked devices or assigning them a human-understandable identification. FIG. 12 illustrates a view of a 3D model where four lights and two other networked devices (e.g., power outlets) have been registered and assigned human-understandable identifications in registration 106. The assigned names can be manually selected from lists, manually entered, or automatically generated. If automatically generated, the locations of the networked devices can be used to name devices, and the identification signals used during registration 106 can provide a device type to inform the naming process of the registration 106. For instance, in FIG. 12, registration 106 may indicate that the wall outlet is located on an East wall of the room, and hence “East” and “Wall” can be used if an automatically generated name is used. In some embodiments, the user interface of the central application 1016 or the imaging device 1014 may appear as FIG. 12, and enable one to move around in a 3D model of a building while naming and viewing networked devices.

When wireless triangulation and/or ranging using signals sent from or received at cellular phones and other devices with wireless radios is combined with geolocation features of the imaging device 1014 (e.g., GPS, WIFI triangulation, accelerometers, gyroscopes, etc.) locations of networked devices 1002, 1004, 1006, 1008, 1010 can be further enhanced.

In an embodiment, the imaging device 1014 (e.g., a cell phone) can be pointed toward a given light or other networked device having a light, and identification and location of the device can be obtained. This can be done without updating a 3D model created in the audit 102, or can be done without creating a 3D model if one was not created in the audit 102. For instance, a user could walk through a building and point a cell phone's camera at each light or other networked device having a light that the user sees. This process would enable each light to be identified via the unique flickering or dimming pattern of each light or other networked device having a light, and location could be obtained via a combination of wireless triangulation, ranging, and other geospatial locating technologies of the cell phone (e.g., GPS, wireless triangulation, accelerometers, and gyroscopes, to name a few). Additionally, as more and more networked devices are added to the device network 1012 and their locations are determined, the located devices could be used in combination with other technologies to further enhance the location-accuracy of additional registrations of devices (e.g., lights that are already part of the device network 1012 can further add to the accuracy of triangulation and wireless ranging performed by the imaging device 1014 in combination with triangulation and wireless ranging performed by the gateway 1020).

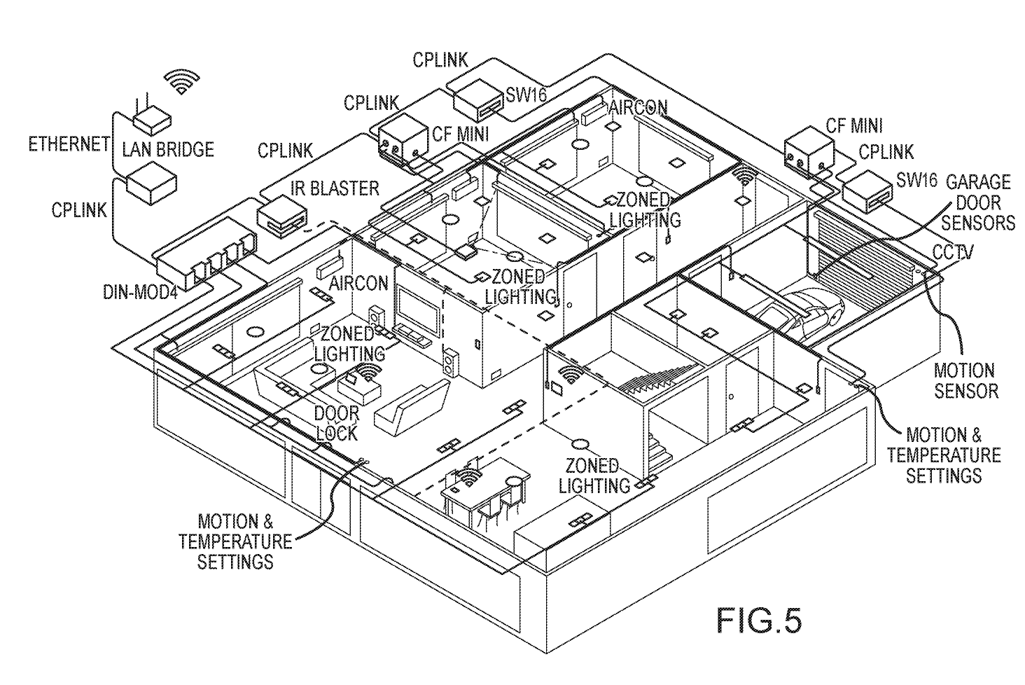

As noted, the 2D schematic or 3D model can either be generated during the optional audit 102, and updated during registration 106, or can be first generated during the registration 106 process. For instance, as identifications of devices 1002, 1004, 1006, 1008, 1010 are obtained by the imaging device 1014, the imaging device 1014 can simultaneously build a 3D model of the structure including locations of devices. In this way, registration 106 produces a 2D schematic or 3D model of a structure including identifications and visual icons, symbols, or images of the networked devices 1002, 1004, 1006, 1008, 1010 in the structure. Wireless triangulation, wireless ranging, and magnetic field mapping can also be used to generate or enhance the 2D schematic or 3D model. FIG. 4 shows one embodiment of a 3D model of a section of an office building, where locations of overhead recessed lights have been captured. The 3D model enables a user to select one or more of the lights via a touchscreen or other computing device and easily assign multiple lights into different groups (for example, during configuration, 108). Further, as compared to a 2D overhead plan, the 3D model greatly enhances a user's ability to quickly name, group, and assign triggers and automated functions to devices (as discussed relative to configuration 108). FIG. 5 shows another embodiment of such a 3D model including the structure of the building (e.g., walls, windows, doors), and networked devices (e.g., WIFI access points, overhead lights, motion and temperature sensors, audio-visual equipment, HVAC components, motorized blinds, keypads, door locks). The networked devices may include any number of devices and different types of devices, e.g. a first retrofitted light source, a second retrofitted light source, a motion sensor, a light switch, a thermostat, a networked HVAC vent, a computer, a television, a moisture sensor, a light sensor, a door sensor, a window sensor, a decibel meter, and/or a hotel key card switch.

Configuration 108

Once lights and other networked devices are added to the device network, a network address has been assigned to each device, and human-understandable identifiers have been assigned to each device, configuration 108 can begin. Configuration 108 can include grouping lights and other networked devices. For instance, lights and other networked devices can be grouped by room or device type to name two non-limiting examples. In FIG. 5, each room has been tinted with an artificial color to provide a visual indicator of different rooms, a feature that could be implemented to show groupings of lights and other networked devices. Grouping of networked devices can be eased by use of the 3D model, such as that illustrated in FIG. 4, where lights can easily be seen in context. Groupings can be formed by touching individual lights on a touchscreen display (or via use of a mouse or other pointing device) or other networked devises or by tracing an outline around a group of lights or other networked devices that a user intends to group.

Configuration 108 can include assigning triggers. Triggers can include events generated by any networked device that can be used to trigger automated functions. Automated functions are programmed functions that one or more networked devices or groups of networked devices carry out in response to a trigger. For instance, a non-exclusive list of triggers includes, but is not limited to, the following: motion detection via a motion sensor, moisture detection via a moisture sensor, temperature exceeding a threshold as detected by a temperature monitor, switching of a light switch, presence detection via a presence sensor (e.g., a cellular phone moving within a threshold distance of a wireless access point), and luminosity falling below a luminance threshold. Some non-exclusive examples of automated functions include, but are not limited to, the following: switching one or more lights on or off; dimming one or more lights; changing a color produced by one or more lights; changing a temperature in a room or region of a building; locking a door; activating a timer during which other triggers are monitored for (e.g., monitoring for further movement in a room, after initial movement is detected, for a period of five minutes).

While configuration 108 is enhanced via use of the 3D model, 2D maps and schematics such as overhead plans, can also be used.

Configuration 108 can be automated or manual, where manual naming, grouping, and assigning of triggers and automated functions are all aided by use of the 3D model generated in registration 106 or in a combination of audit 102 and registration 106.

FIGS. 11A-11C show three non-limiting embodiments of systems for configuring a device network 1112. FIG. 11A is identical to FIG. 10A with the exception of the imaging device 1014, which here can be replaced by an optional computing device 1150 that is configured to configure the device network 1112. However, in some embodiments, the computing device 1150 can be the imaging device 1014 used in the registration 106. The computing device 1150 can include an optional control module 1152 that can be used through a user interface of the computing device 1150 to configure the device network 1112. Alternatively, configuration 108 can be performed via the central application 1116, which can be web-accessible (FIGS. 11A and 11B) or can be accessed on a local network 1124. FIG. 11B illustrates the system 1100B where a local area network 1124 is utilized, and FIG. 11C illustrates the system 1100C where the central application 1116 resides on the local area network 1124.

Tracking 110

Although there are no system diagrams specifically set forth for the tracking 110 and general use of the device network, one of skill in the art will recognize that such systems will have many similarities to FIGS. 11A-11C.

Once registration 106 is complete and the locations of lights and other networked devices are known, the devices along with any wireless devices in the building (e.g., tablet computers and cellular phones) can be used to track the location of people and devices within the building. For instance, lights can periodically transmit an optical or RF signal that peoples' cell phones or tablets could pick up on. For instance, a cell phone that detects these signals from lights within a hallway, but not signals from any other lights in the building, can send this information to the central application or the gateway, which can use this information to determine that a user associated with the cell phone is in a given hallway. When the cell phone begins to receive light indicators from lights in a nearby office, the building management system will know that the person is transitioning from the hall to the office.

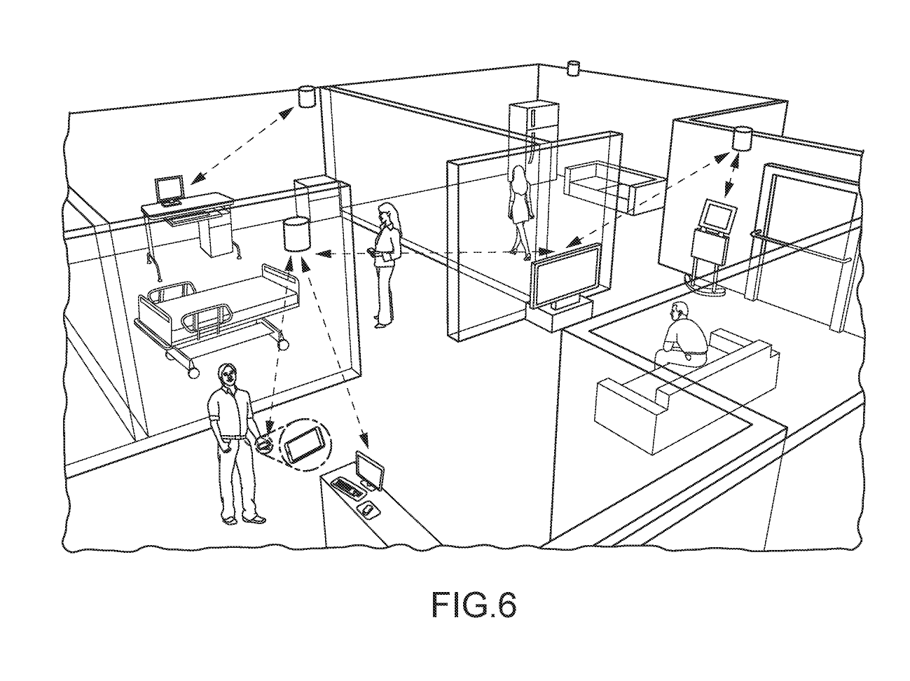

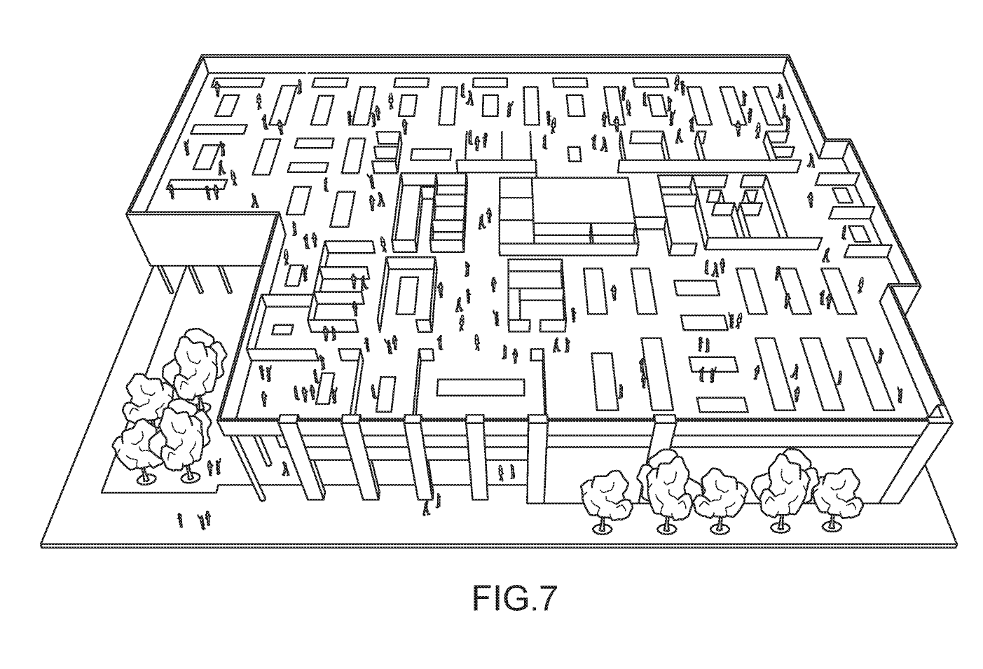

As another example, people often carry cellular phones that are connected to the Internet via wireless gateways (e.g., WIFI access points) within a building. These phones can transmit signals to the networked devices, or the networked devices can transmit signals to the cell phones, and the existence of and/or signal strength of these signals can be relayed to a gateway or the central application, or some other processor, able to determine a location based on these signals. While the use of wireless triangulation, GPS, and other geolocation features of cell phones is well known in the art when used alone, these features can be greatly enhanced when combined with location information derived from signals transmitted to or received by networked devices having known locations (e.g., 1002, 1004, 1006, 1008, 1010). FIG. 6 illustrates an example of an office where various networked devices generating and receiving signals are used to track the locations of cell phones, tablets and other devices, and hence of the users of those devices. When these features are combined with the 3D model from the audit 102 and the registration 106, 3D models including locations of people and objects (with periodic or real-time updates), such as illustrated in FIG. 7, can be generated. In FIG. 7, images or symbols of people are included to mark the locations of devices such as cellular phones, and animations can be included to indicate that an inferred person is at the location where a cell phone or other device is determined to be.

Magnetic anomaly detection, as discussed relative to the audit 102 and registration 106, and/or RF ranging or triangulation constitute just a few other methods that can be used to track persons and object within a building once the locations of networked devices are known.

Providing real-time or periodic locations of people and objects in a building provides numerous sources of triggers for HVAC and lighting systems controlled by the building management system and/or the central application. For instance, lights could be dimmed or turned off based on occupancy of a room where occupancy sensors would not be needed. Alternatively, HVAC systems could turn down a temperature in a room when the building management system detects that more than a threshold number of people have congregated in a certain room, thereby preempting the inevitable rise in temperature that will result from the mass of human bodies.

Miscellaneous Qualifiers

While the herein-described systems and methods have often referenced WIFI, BLUETOOTH, ZIGBEE, and Z-WAVE, those of skill in the art will recognize that the systems and methods are protocol agnostic. For instance, ENOCEAN and GAINSPAN are two other non-limiting examples of wireless protocols that can be used with the herein described systems, methods, and apparatus. Further, different types of wireless networks can be used, whether they be hub-based (e.g., WIFI), point-to-point (PPP), or mesh (e.g., ZIGBEE and Z-WAVE).

So, for example in a retail environment, a customer's location might be tracked by receiving periodic “pings” from the customer's cell phone in response to a WIFI or BLE signal from a plurality of gateways. The gateways have known locations, so the cell phone's location can be triangulated. Similar technology can be used to track employee locations within buildings.

The imaging device can include a single camera or multiple cameras (to provide stereoscopic data regarding the structure). The imaging device can also include LIDAR technology in addition to or as an alternative to traditional 2D and 3D cameras. Whatever imaging device is used, video or photos can be taken and used to (1) identify lights and other networked devices having lights, (2) obtain locations of the devices, and (3) create or update a 3D model of the structure where the devices are located.

The imaging device can include one or more optical sensors and hardware, software, and/or firmware configured to convert signals from the optical sensor(s) into digital data that is readable by a computing device. The imaging device can also include a computing device including a wireless transceiver. The optical sensors can be integral with the computing device or part of a separate computing device that can be coupled to a second computing device. For instance, the imaging device can be a stereoscopic imaging device selectively affixed to a tablet computer or cellular phone and in communication with the tablet computer or cellular phone via either a wired (e.g., USB) or wireless (BLUETOOTH) connection. In other embodiments, the imaging device can be the camera of a cellular phone or tablet computer. These are just two examples of the many ways that the imaging device can be implemented.

Networked devices can include lights, switches, motion sensors, proximity sensors, controllable HVAC vents (KEEN HOME SMART VENT, and ECOVENT), temperature sensors, humidity sensors, thermostats, automated blinds, speakers, motorized projectors, audio-visual equipment, video cameras, keypads, and door locks, to name a few non-limiting examples.

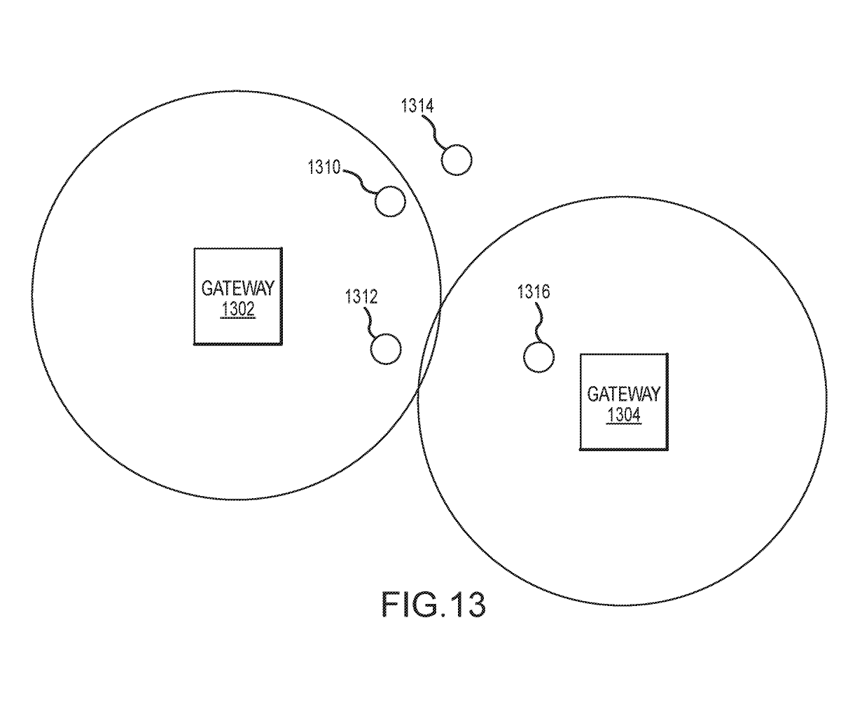

FIG. 13 illustrates an embodiment where lights or other networked devices can be used to increase wireless coverage in a building. Often gateways cannot be placed throughout a building to provide perfect coverage for all areas. In some cases this would be cost-prohibitive and in some cases infrastructure, such as limits on existing power and Ethernet locations, prevents ideal gateway placement. In other situations, the structure of the building itself may present obstacles to ideal wireless coverage. Alternatively, changes in building structure, for instance, when a new firm moves into a space and remodels the space, moving walls, rearranging electrical, adding metal piping, etc. All of these structural obstacles and changes can place limits on gateway coverage.

FIG. 13 shows a first gateway 1302, and its coverage area. A second gateway 1304 has a second coverage are with a slight overlap in the coverage of the two gateways 1302, 1304. The illustrated coverage is sufficient to provide wireless connectivity to three of four lights or other networked devices 1310, 1312, 1316. However, a fourth device 1314 is outside of both coverage areas, and therefore does not have access to the network. However, the devices 1310, 1312, 1314, 1316 can send low power signals able to reach nearby devices 1310, 1312, 1314, 1316 without first passing these signals through a gateway. Mesh networks and peer-to-peer networks are examples of just two such technologies that allow device-to-device communication without an intermediary access point. In the illustrated embodiment, devices 1312, 1316, and 1310 may be too far apart to talk directly, however, devices 1310 and 1314 may be close enough to talk directly. Thus, device 1310 can be aware of device 1314′s location and existence even if neither gateway 1302 and 1304 can reach this device 1314. Device 1310 can relay this information back to the gateway 1302, and the network can decide to make device 1310 a repeater for the network. In this way, device 1310 could receive signals from gateway 1302, pass those signals to device 1314, receive signals from device 1314, and pass those signals to gateway 1302. In this way, the system enables device 1314 to be included in the network even where wireless gateway coverage is insufficient to otherwise include device 1314.

While only a single gateway 1020, 1120 is illustrated as having communications with the lights 802, 804, 806 and the other networked devices 808, 810, in other embodiments, the functionality of the gateway 1020, 1120 can be distributed among multiple gateways and those multiple gateways can vary in type. For instance, the functionality of gateway 1020, 1120 can be distributed between one or more of the following types of gateways, to name a few non-limiting examples: WIFI, ENOCEAN, BLUETOOTH, and/or ZIGBEE or Z-WAVE. WIFI hotspots such as those in cellular phones and USB drives plugged into laptop computers are just two other examples of gateways across which the functionality of gateway 1020, 1120 can be distributed.

Although FIGS. 8-11C illustrate three lights and two devices, one of skill in the art will recognize that these are illustrative examples only and that any number or type of lights and/or devices can be implemented. For instance, most commercial retrofit projects will include hundreds of lights, light switches, and motion detectors.

Variations on Hardware Implementations

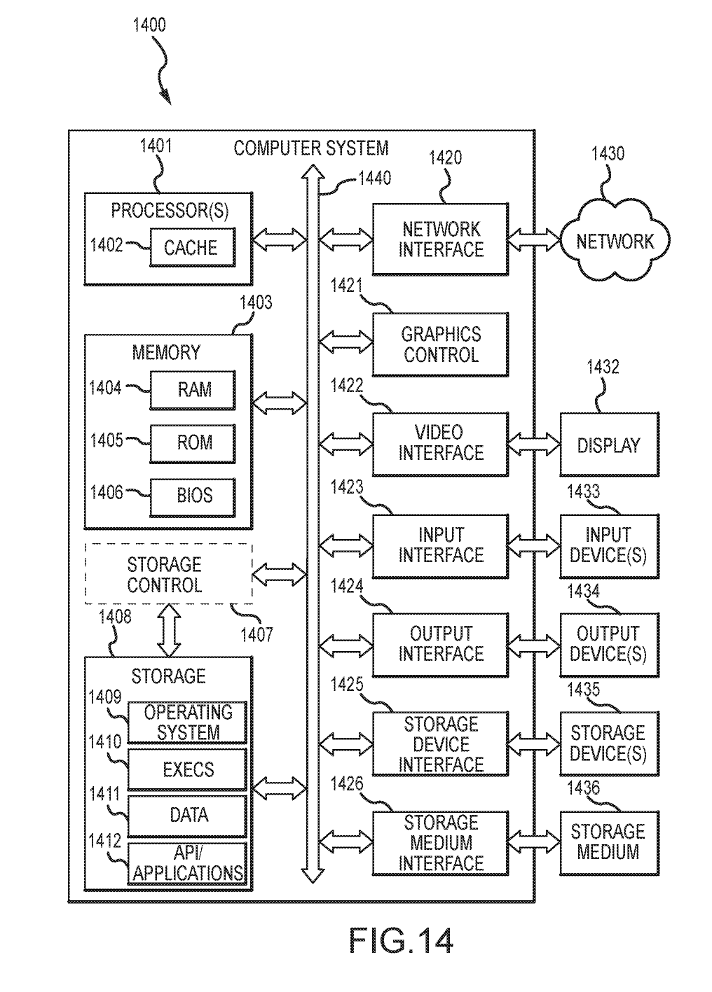

The systems and methods described herein can be implemented in a computer system in addition to the specific physical devices described herein. FIG. 14 shows a diagrammatic representation of one embodiment of a computer system 1400 within which a set of instructions can execute for causing a device to perform or execute any one or more of the aspects and/or methodologies of the present disclosure. The building management system 1019 in FIG. 10 is one implementation of the computer system 1400. The components in FIG. 14 are examples only and do not limit the scope of use or functionality of any hardware, software, firmware, embedded logic component, or a combination of two or more such components implementing particular embodiments of this disclosure. Some or all of the illustrated components can be part of the computer system 1400. For instance, the computer system 1400 can be a general purpose computer (e.g., a laptop computer) or an embedded logic device (e.g., an FPGA), to name just two non-limiting examples.

Computer system 1400 includes at least a processor 1401 such as a central processing unit (CPU) or an FPGA to name two non-limiting examples. The gateway 1020 can include a processor such as the processor 1401. The computer system 1400 may also comprise a memory 1403 and a storage 1408, both communicating with each other, and with other components, via a bus 1440. The bus 1440 may also link a display 1432, one or more input devices 1433 (which may, for example, include a keypad, a keyboard, a mouse, a stylus, etc.), one or more output devices 1434, one or more storage devices 1435, and various non-transitory, tangible computer-readable storage media 1436 with each other and with one or more of the processor 1401, the memory 1403, and the storage 1408. All of these elements may interface directly or via one or more interfaces or adaptors to the bus 1440. For instance, the various non-transitory, tangible computer-readable storage media 1436 can interface with the bus 1440 via storage medium interface 1426. Computer system 1400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 1401 (or central processing unit(s) (CPU(s))) optionally contains a cache memory unit 1402 for temporary local storage of instructions, data, or computer addresses. Processor(s) 1401 are configured to assist in execution of computer-readable instructions stored on at least one non-transitory, tangible computer-readable storage medium. Computer system 1400 may provide functionality as a result of the processor(s) 1401 executing software embodied in one or more non-transitory, tangible computer-readable storage media, such as memory 1403, storage 1408, storage devices 1435, and/or storage medium 1436 (e.g., read only memory (ROM)). For instance, the method 100 in FIG. 1 may be embodied in one or more non-transitory, tangible computer-readable storage media. The non-transitory, tangible computer-readable storage media may store software that implements particular embodiments, such as the method 100 and processor(s) 1401 may execute the software. Memory 1403 may read the software from one or more other non-transitory, tangible computer-readable storage media (such as mass storage device(s) 1435, 1436) or from one or more other sources through a suitable interface, such as network interface 1420. The gateway 1020 can include network interface embodying the components and functionality of the network interface 1420. The software may cause processor(s) 1401 to carry out one or more processes or one or more steps of one or more processes described or illustrated herein. Carrying out such processes or steps may include defining data structures stored in memory 1403 and modifying the data structures as directed by the software. In some embodiments, an FPGA can store instructions for carrying out functionality as described in this disclosure (e.g., the method 100). In other embodiments, firmware includes instructions for carrying out functionality as described in this disclosure (e.g., the method 100).

The memory 1403 may include various components (e.g., non-transitory, tangible computer-readable storage media) including, but not limited to, a random access memory component (e.g., RAM 1404) (e.g., a static RAM “SRAM”, a dynamic RAM “DRAM, etc.), a read-only component (e.g., ROM 1405), and any combinations thereof. ROM 1405 may act to communicate data and instructions unidirectionally to processor(s) 1401, and RAM 1404 may act to communicate data and instructions bidirectionally with processor(s) 1401. ROM 1405 and RAM 1404 may include any suitable non-transitory, tangible computer-readable storage media described below. In some instances, ROM 1405 and RAM 1404 include non-transitory, tangible computer-readable storage media for carrying out the method 100. In one example, a basic input/output system 1406 (BIOS), including basic routines that help to transfer information between elements within computer system 1400, such as during start-up, may be stored in the memory 1403.

Fixed storage 1408 is connected bidirectionally to processor(s) 1401, optionally through storage control unit 1407. Fixed storage 1408 provides additional data storage capacity and may also include any suitable non-transitory, tangible computer-readable media described herein. Storage 1408 may be used to store operating system 1409, EXECs 1410 (executables), data 1411, API applications 1412 (application programs), and the like. For instance, the storage 1408 could be implemented for storage of the database 1018 as described in FIGS. 10A-C. Often, although not always, storage 1408 is a secondary storage medium (such as a hard disk) that is slower than primary storage (e.g., memory 1403). Storage 1408 can also include an optical disk drive, a solid-state memory device (e.g., flash-based systems), or a combination of any of the above. Information in storage 1408 may, in appropriate cases, be incorporated as virtual memory in memory 1403.

In one example, storage device(s) 1435 may be removably interfaced with computer system 1400 (e.g., via an external port connector (not shown)) via a storage device interface 1425. Particularly, storage device(s) 1435 and an associated machine-readable medium may provide nonvolatile and/or volatile storage of machine-readable instructions, data structures, program modules, and/or other data for the computer system 1400. In one example, software may reside, completely or partially, within a machine-readable medium on storage device(s) 1435. In another example, software may reside, completely or partially, within processor(s) 1401.

Bus 1440 connects a wide variety of subsystems. Herein, reference to a bus may encompass one or more digital signal lines serving a common function, where appropriate. Bus 1440 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1400 may also include an input device 1433. In one example, a user of computer system 1400 may enter commands and/or other information into computer system 1400 via input device(s) 1433. Examples of an input device(s) 1433 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 1433 may be interfaced to bus 1440 via any of a variety of input interfaces 1423 (e.g., input interface 1423) including, but not limited to, serial, parallel, game port, USB, FIREWIRE, THUNDERBOLT, or any combination of the above.

In particular embodiments, when computer system 1400 is connected to network 1430 (such as the local network 1024 illustrated in FIGS. 10B-C or the Internet 1022), computer system 1400 may communicate with other devices, such as mobile devices and enterprise systems, connected to network 1430. Communications to and from computer system 1400 may be sent through network interface 1420. For example, network interface 1420 may receive incoming communications (such as requests or responses from other devices) in the form of one or more packets (such as Internet Protocol (IP) packets) from network 1430, and computer system 1400 may store the incoming communications in memory 1403 for processing. Computer system 1400 may similarly store outgoing communications (such as requests or responses to other devices) in the form of one or more packets in memory 1403 and communicated to network 1430 from network interface 1420. Processor(s) 1401 may access these communication packets stored in memory 1403 for processing.

Examples of the network interface 1420 include, but are not limited to, a network interface card, a modem, and any combination thereof. Examples of a network 1430 or network segment 1430 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. For instance, the local network 1024 of FIGS. 10B-C is one exemplary implementation of the network 1430. A network, such as network 1430, may employ a wired and/or a wireless mode of communication. In general, any network topology may be used.

Information and data can be displayed through a display 1432. Examples of a display 1432 include, but are not limited to, a liquid crystal display (LCD), an organic liquid crystal display (OLED), a cathode ray tube (CRT), a plasma display, and any combinations thereof. The display 1432 can interface to the processor(s) 1401, memory 1403, and fixed storage 1408, as well as other devices, such as input device(s) 1433, via the bus 1440. The display 1432 is linked to the bus 1440 via a video interface 1422, and transport of data between the display 1432 and the bus 1440 can be controlled via the graphics control 1421.

In addition to a display 1432, computer system 1400 may include one or more other peripheral output devices 1434 including, but not limited to, an audio speaker, a printer, and any combinations thereof. Such peripheral output devices may be connected to the bus 1440 via an output interface 1424. Examples of an output interface 1424 include, but are not limited to, a serial port, a parallel connection, a USB port, a FIREWIRE port, a THUNDERBOLT port, and any combinations thereof.

In addition or as an alternative, computer system 1400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Within this specification, the same reference characters are used to refer to terminals, signal lines, wires, etc. and their corresponding signals. In this regard, the terms “signal,” “wire,” “connection,” “terminal,” and “pin” may be used interchangeably, from time-to-time, within the this specification. It also should be appreciated that the terms “signal,” “wire,” or the like can represent one or more signals, e.g., the conveyance of a single bit through a single wire or the conveyance of multiple parallel bits through multiple parallel wires. Further, each wire or signal may represent bi-directional communication between two, or more, components connected by a signal or wire as the case may be.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein (e.g., the method 100) may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable strage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

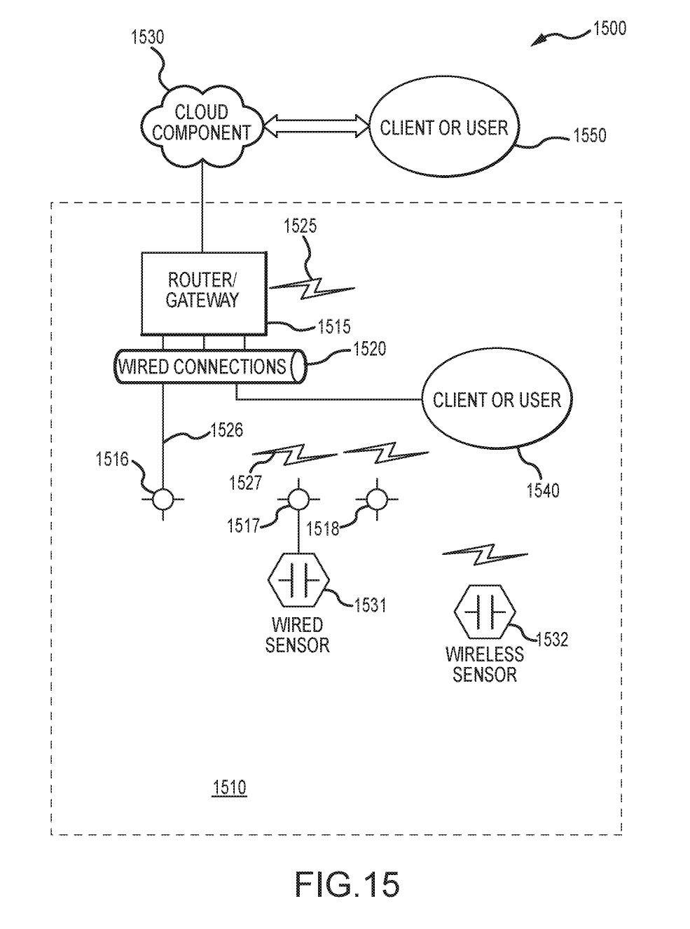

The methods described in connection with the embodiments disclosed herein may be embodied directly in hardware, in processor-executable code encoded in a non-transitory tangible processor readable storage medium, or in a combination of the two. Referring to FIG. 15 for example, shown is a block diagram depicting physical components that may be utilized to realize the imaging device (814, 914, 1014), gateway (920, 1020, 1120), a remote server executing the central application (816, 916, 1016, 1116), and/or a computing device (1150), according to an exemplary embodiment. As shown, in this embodiment a display portion 1512 and nonvolatile memory 1520 are coupled to a bus 1522 that is also coupled to random access memory (“RAM”) 1524, a processing portion (which includes N processing components) 1526, an optional field programmable gate array (FPGA) 1527, and a transceiver component 1528 that includes N transceivers. Although the components depicted in FIG. 15 represent physical components, FIG. 15 is not intended to be a detailed hardware diagram; thus many of the components depicted in FIG. 15 may be realized by common constructs or distributed among additional physical components. Moreover, it is contemplated that other existing and yet-to-be developed physical components and architectures may be utilized to implement the functional components described with reference to FIG. 15.

This display portion 1512 generally operates to provide a user interface for a user, and in several implementations, the display is realized by a touchscreen display. In general, the nonvolatile memory 1520 is non-transitory memory that functions to store (e.g., persistently store) data and processor-executable code (including executable code that is associated with effectuating the methods described herein). In some embodiments for example, the nonvolatile memory 1520 includes bootloader code, operating system code, file system code, and non-transitory processor-executable code to facilitate the execution of the method 100 as described with reference to FIG. 1 described further herein. In an embodiment, nonvolatile memory 1520 could be implemented for storage of the database 1018 as described in FIGS. 10A-C. For instance, the nonvolatile memory 1520 could be implemented to store device locations and/or device identifications. It could also be used to store configuration files used to automatically control devices such as lights and sensors.

In many implementations, the nonvolatile memory 1520 is realized by flash memory (e.g., NAND or ONENAND memory), but it is contemplated that other memory types may be utilized as well. Although it may be possible to execute the code from the nonvolatile memory 1520, the executable code in the nonvolatile memory is typically loaded into RAM 1524 and executed by one or more of the N processing components in the processing portion 1526.

The N processing components in connection with RAM 1524 generally operate to execute the instructions stored in nonvolatile memory 1520 to enable wireless auditing, commissioning, and configuring of LED lights and other networked devices such as motion sensors, thermostats, and humidity sensors, to name a few. For example, non-transitory, processor-executable code to effectuate the methods described with reference to FIG. 1 may be persistently stored in nonvolatile memory 1520 and executed by the N processing components in connection with RAM 1524. As one of ordinarily skill in the art will appreciate, the processing portion 1526 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 1526 may be configured to effectuate one or more aspects of the methodologies described herein (e.g., the method described with reference to FIG. 1). For example, non-transitory processor-readable instructions may be stored in the nonvolatile memory 1520 or in RAM 1524 and when executed on the processing portion 1526, cause the processing portion 1526 to perform wireless auditing, commissioning, and configuration of LEDs and other networked devices. Alternatively, non-transitory FPGA-configuration-instructions may be persistently stored in nonvolatile memory 1520 and accessed by the processing portion 1526 (e.g., during boot up) to configure the hardware-configurable portions of the processing portion 1526 to effectuate the functions of the imaging device (814, 914, 1014), gateway (920, 1020, 1120), a remote server executing the central application (816, 916, 1016, 1116), and/or a computing device (1150). In some embodiments, an FPGA can store instructions for carrying out functionality as described in this disclosure (e.g., the method 100). In other embodiments, firmware includes instructions for carrying out functionality as described in this disclosure (e.g., the method 100).

The input component 1530 operates to receive signals (e.g., images and video from the optional imaging device 822, radio signals from lights and other networked devices, visible and IR indicators that represent a network address for lights and networked devices, to name a few) that are indicative of one or more aspects of the herein disclosed systems for auditing, registering, and configuring lights and other networked devices, as well as those for tracking using commissioned lights and other networked devices. The output component generally operates to provide one or more analog or digital signals to effectuate an operational aspect of the imaging device (814, 914, 1014), gateway (920, 1020, 1120), remote server executing the central application (816, 916, 1016, 1116), and/or computing device (1150). For example, the output portion 1532 may provide the scanned barcode identifier to the gateway 1020 as described with reference to FIGS. 10a-c. When the imaging device 1014 is realized by a smartphone, for example, the imaging device 1014 may send a WiFi or cellularly-transmitted instruction to one or more of the LED lights 1002, 1004, 1006 to display or signal (e.g., optical or RF) their unique identifier.

The depicted transceiver component 1528 includes N transceiver chains, which may be used for communicating with external devices via wireless or wireline networks. Each of the N transceiver chains may represent a transceiver associated with a particular communication scheme (e.g., WiFi, Ethernet, Profibus, etc.). The transceiver component 1528 could be embodied in any of the herein disclosed gateways (e.g., 920, 1020, 1120). For instance, the local network 1024 of FIGS. 10B-C could be coupled to the device 1500 through the transceiver component 1528.

The present disclosure provides a lighting system that is also an information appliance. For the purposes of the present disclosure, the term “information appliance” refers to a system that serves as a two-way bridge to transfer information from the source of information (i.e., a sensor located at or near an LED light fixture) to an external location, such as a cloud server. The information appliance system performs data acquisition, processing, and control of devices within a building through a network of sensors and light fixtures that communicate with a local router, a remote cloud-based component, and one or more user interfaces.

A system 1500 in accordance with some embodiments is depicted in the high-level diagram of FIG. 15. Shown is a building premises 1510, the boundaries of which are represented by the dashed rectangular outline. The system 1500 includes a cloud data storage 1530 (the “cloud” or “cloud component”) which may be embodied in a hosted website, a server, a database, or a software program that, in the embodiment depicted, is external and/or remote in relation to the building premises 1510. In some embodiments, the cloud component 1530 may be physically located within the building premises 1510. In order to implement the features of the cloud component 1530 as described herein, the cloud component 1530 may comprise a remote computer or server that can store data, process it, execute instructions for controlling the light fixtures and sensors, and communicate back and forth between the user interface and the light fixtures and sensors. The cloud component 1530 will be described in greater detail throughout the disclosure.

Within the building premises 1510 is a router or gateway 1515 which communicates directly with lights and sensors that are also within the building premises 1510 via one or several wired or wireless protocols. Light fixtures and/or sensors may be connected to the router/gateway 1515 in order to transfer data either via wired connections 1520 or wireless connections 1525. For the purposes of the present disclosure, these light fixtures may be referred to as “controls-ready” light fixtures, which may comprise hardware, software, or a combination of hardware and software that enables the controls-ready light fixture to function as described in this disclosure. The controls-ready light fixture may be an LED light, and may be referred to simply as an LED, a light fixture, or a “smart” lighting device, and may be assumed to be a controls-ready light fixture in each case unless otherwise specified.

Wired connections 1520 may include any physical cabling known in the art for transferring data, such as Ethernet, telephone, fiber-optic, or other lines. Wireless connections 1525 may include any short or long-range wireless communication protocol, such as near-field communication (NFC), radio frequency (RF), Wi-Fi, or cellular protocols. Many embodiments may utilize short to mid-range RF or Wi-Fi communication protocols, though, because of their utility and applicability in a building environment. Although just a few exemplary light fixtures and sensors are depicted in FIG. 15, many such fixtures—numbering into the hundreds or even thousands—may be connected via the wired and wireless connections 1520 and 1525 in some embodiments.

Light fixtures 1516, 1517, and 1518 are shown and may be connected to the building's line voltage in order to receive power. In some embodiments, the line voltage may also serve as a data conduit (e.g., in embodiments utilizing Power over Ethernet), but in the present example depicted in FIG. 15, the wired lines (e.g., line 1526) and wireless connections (e.g., network connection 1527) depicted represent how data is transferred to and from the router, and not necessarily how power is transferred. Throughout the figures, data connections may be represented by lines when they are hard-wired and by the “lightning bolt” icon when they are wireless.

The system also may include several sensors, such as wired sensor 1531 and wireless sensor 132. The sensors 1531 and 1532 may either communicate directly with the router/gateway 1515 or communicate via one or more LED lights with which they may be paired. Alternatively, the sensors 1531 and 1532 may solely communicate with and control LED lights with which they are paired. For example, the sensor 1531 may be a motion sensor, and may be paired with the LED light 1517. When the sensor 1531 senses motion near the light, it may send that information onto the LED light 1517 that instructs the light 1517 to become brighter. The LED light 1517 is depicted as being wirelessly connected; it may be wireles sly connected to other LED lights in the system as well as to the router/gateway 1515. The LED light 1517 may therefore transmit information received from the sensor 1531 to other nearby lights in order to instruct them to become brighter as well. The LED light 1517 may also simultaneously transmit the sensor's 1531 information to the router/gateway 1515 in order to provide building occupancy information.

Information that is sent from the various lights and sensors to the router/gateway 1515 may be sent to a local client or user interface 1540, or to the remote cloud component 1530, or to both. If the information is sent to the remote cloud component 1530, it may then be sent on to a remote client or user interface 1550. Therefore, information from the sensors may either be sent to a local or remote user interface 1540 or 1550. One function of the cloud component 1530 is that it may aggregate information from all the various light fixtures and present the information in a useful format to a local or remote user, who may be an administrator of the system. For example, motion sensor information from sensor 1531 and other sensors throughout the building may be aggregated to provide an overall state of building occupancy by area or room of the building, and may be used to identify security concerns.

The type of information that may be received by the sensors, communicated to and through the LED lights, aggregated by the cloud component 1530, and displayed on a user interface are as varied as the types of sensors available and the numerous ways to use their gathered information. For example, energy consumption information about the entire building may be gathered via sensors that detect the energy being used by appliances, heating and cooling devices, and business equipment within the building, as well as energy consumed by the LED lights themselves. This information may be provided to a user on the local or remote user interface 1540 or 1550, and then controlled by the user or by a utility client. The utility client may then, if permission is granted, act to control the lights to dim them, for example, in order to reduce the energy usage of the lighting system during periods of high energy consumption. Such control over energy usage may be automated by appropriate software on the cloud component 1520.

Another aspect of the present disclosure is that the various “smart” lights and sensors of the system may be equipped with a processor, memory, and software executed thereon in order to function autonomously in the event that connections to the gateway or other parts of the local network fail to operate. For example, an LED light of the system may be equipped to sense a loss of connection to one or more parts of the network, which may trigger the light to function in an autonomous state. In the autonomous state, an LED light that is temporarily not connected to the router/gateway may still receive data from sensors to which it is still connected, and may still respond according to the received information. For example, the LED light 1517 could still receive information about detected motion from sensor 1531 and increase in brightness accordingly. In some embodiments, LED lights and/or sensors may store data received while disconnected and then deliver it to the router/gateway once reconnected. Details of this functionality will be described in more detail later in the disclosure.

In order to facilitate the installation and connection of an LED lighting system, LED lights and sensors themselves may be equipped with provisioning software. It is known in the art that in order to connect wired or wireless communication devices onto a network, the devices must be provisioned onto the network, namely by providing identification and authentication information from the device to the network and vice versa. Authentication information can comprise passcodes, keys, and unique identification signals that verify that a particular device should belong to a given network. Though there are some types of “smart” devices, such as thermostats and smoke detectors that communicate with a network once connected, such devices are typically provisioned by a higher-level computer, such as a home or office personal computer. Often, such sensors do not contain provisioning software that initiates a provisioning protocol within the devices themselves. LED lighting devices, modules and systems typically do not contain provisioning software either. Provisioning (also known as “onboarding” or “commissioning”) protocols vary depending on the type of network being connected to, but one common feature of provisioning in wireless local area networks (WLANs) and RF networks (including peer-to-peer and mesh networks) is that devices in a particular area may be connected to each other based in part on their proximity to each other. Sensors and lights in systems described herein may be in close proximity within a designated area, such as a room, a hallway, or a floor of a building. The sensors and lights in a designated area may therefore be provisioned in a way that both identifies their location and establishes a data connection.

In various embodiments, several ways to provision multiple devices in a short period of time are provided. Because many LED lighting devices and sensors themselves may comprise provisioning software for initiating provisioning protocols, several LEDs and sensors that are in close proximity to each other can provision each other in sub-groups. It can be time-consuming to provision many devices to a network individually, and it is contemplated that systems 1500 described herein may comprise hundreds, or even thousands of individual lights and/or sensors.

In some embodiments, and as illustrated in FIG. 15, the lights and/or sensors may use a provisioning protocol that involves the sending and detecting of flashing light signals in a particular pattern. For example, a new sensor, such as a carbon dioxide sensor, may be placed in a room with a number of existing and LED lights which are all connected to the router/gateway 1515. The sensor may be equipped with a photodiode that can detect flashes of light and may contain provisioning software that correlates received patterns of flashes as authentication signals. The router/gateway 1515 may also be equipped with similar provisioning software that instructs the LED lights 1517, 1518 in the same room as the carbon dioxide sensor (which may be a wireless sensor such as the sensor 1532) to flash in a particular pattern. When the lights flash to initiate a provisioning protocol, the carbon dioxide sensor's photodiode may detect the flashing sequence and respond by sending information (e.g., through a radio frequency signal) to establish a data connection.

One advantage of flashing lights in a particular room in a particular pattern is that multiple sensors that detect the particular pattern may be provisioned at the same time. Another advantage is that the sensors, once connected to the router/gateway, can communicate to the router/gateway which particular signal that was used to provision it onto the network, thereby identifying which area of the building the sensors are in.

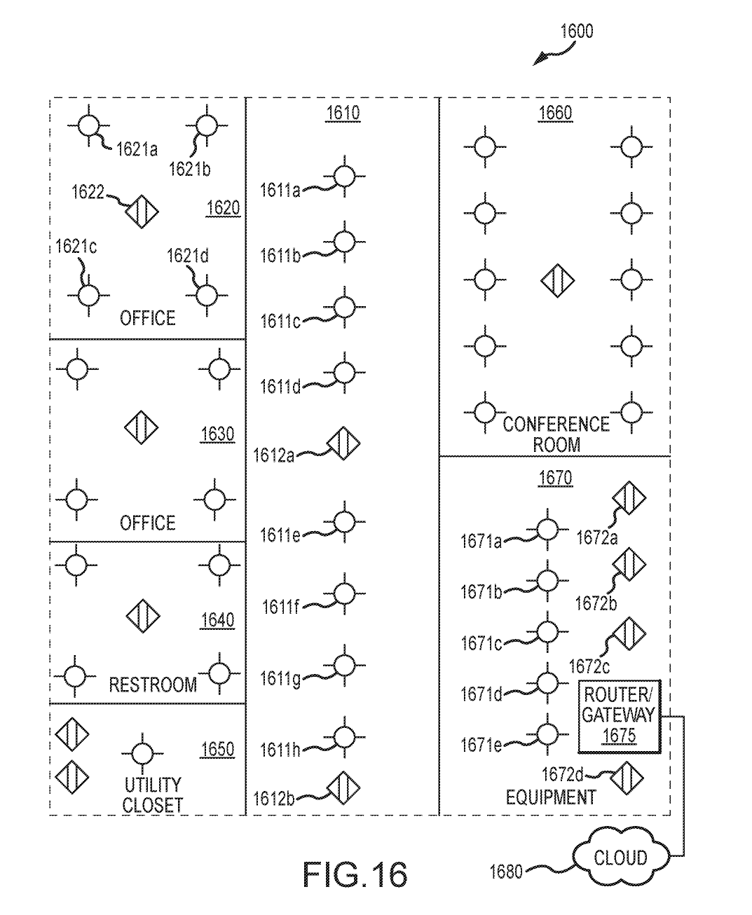

To illustrate how this method of provisioning may identify the locations of particular sensors, consider FIG. 16, which shows a schematic diagram of a floor 1600 of a commercial building according to some embodiments. The floor 1600 may have distinct areas such as a hallway 16210, offices 1620 and 1630, a restroom 1640, a utility closet 1650, a conference room 1660, and an equipment room 1670. As shown, each distinct area may be substantially enclosed by walls, and each area such as office 1620, may have one or more light fixtures 1621a-1621d, and one or more sensors 1622. The hallway may have one or more light fixtures 1611a-h. It may also have two appropriate sensors 1612a and 1612b, which may be, for example, a combination smoke/heat detector and a motion sensor. The office 1620 may have fewer light fixtures 1621a-1621d and just one motion detector sensor 1622 because it is used like a traditional office, with only one person using it most of the time. The equipment room 1670, may have several lights 1671a-e and a number of sensors 1672a-d, because it may house servers or industrial equipment that generate large amounts of heat and consume large amount of energy. Therefore, the sensors may be more robust than those in other distinct areas of the floor 1600 and include those for monitoring heat, smoke, volatile organic compounds, energy consumption, air pressure, humidity, and other environmental cues.

In some embodiments, one or more router/gateways 1515, 1675 may be provided, as illustrated in FIGS. 15-16. Depending on the layout of a particular area of a building, there may be more or fewer router/gateways 1515, 1675. In some embodiments, multiple router/gateways 1515, 1675 may be implemented because the lights 1621a-1621d and sensors 1622 may have limited communication ranges. In some embodiments, each router/gateway 1515, 1675 may have a longer wireless communication range than most LED lights 1621a-1621d and sensors 1622. For example, the router/gateways 1515, 1675 may be equipped for Wi-Fi and/or cellular data communication, whereas some LED lights 1621a-1621d or sensors 1622 may be equipped for Bluetooth or Zigbee communication. Those skilled in the art will understand that enough router/gateways 1515, 1675 should be provided, so as to communicate with each of the lights 1621a-1621d and sensors 1622 in the system 1500, 1600. The router/gateways 1515, 1675 may communicate with each other and/or with the cloud component 1530, 1680. In some cases, to avoid redundancy of communication, each of the router/gateways may communicate to each of the other router/gateways 1515, 1675, and then one designated router/gateway (e.g., router/gateway 1515, 1675) may communicate relayed information to the cloud component 1530, 1680. The order of how the router/gateways 1515, 1675 may communicate to each other and to the cloud component 1530, 1680 may be predetermined by a hierarchy. In some embodiments, each router/gateway 1515, 1675 may still be capable of communicating directly with a first cloud component 1530, 1680, such as in the event that other router/gateways 1515, 1675 are temporarily unable to communicate.

As an example of how light fixtures and sensors may be provisioned by other light fixtures, and as illustrated in FIG. 16, a first light fixture 1621a may be installed first and connected to a local area network, and may have a wired or wireless connection to the router/gateway 1515, 1675 in the office 1620. The first light fixture may be manually provisioned onto the network, (e.g., by a user entering authentication information on a personal computer) and may have an IP address that identifies its location to the router/gateway 1515, 1675. Then, the other light fixtures 1621b-1621d and the sensor 1622 may be installed. Then, instead of provisioning each of the light fixtures 1621b-d and the sensor 1622 manually, the router/gateway 1515, 1675 (via the user interface 1540, 1550 and/or cloud component 1530, 1680) may instruct the first light fixture 1621a to flash the lights in a particular pattern that would be recognizable to the other light fixtures 1621b-d and the sensor 1622 as an initiation of a provisioning protocol. The flashing light from the first light fixture 1621a may only be visible to the light fixtures and sensors within the office 1620 due to the walls. Therefore, all the light fixtures and sensor(s) that are provisioned in response to the flashing light signal can be identified or self-identify as being in the same distinct area of the floor 1600. Further details regarding the provisioning will be discussed later in this disclosure.

In some embodiments, each of the light fixtures 1621a-1621d may include a small light and photosensor to facilitate commissioning/provisioning. In some embodiments, the router/gateway 1515, 1675 may instruct a first light fixture 1621a to record a signal level of a radio frequency transmission of an as-yet to be provisioned light fixture 1621b as an initiation of a provisioning protocol. That is, the light fixtures and sensor(s) may be provisioned in response to the first light fixture determining that the strength of an RF signal emitted by another light fixture or sensor is sufficient to identify it as being in the same distinct area of the floor 1600.

Similarly, a first light fixture 1621a may include a sensor and processing circuitry configured to recognize a light intensity of a photosensor on a second light fixture 1621b (or vice versa), and, responsive to the recognizing, determine that the first and second light fixtures 1621a, 1621b are in the same distinct area of the floor 1600, or within a certain range or distance from each other.

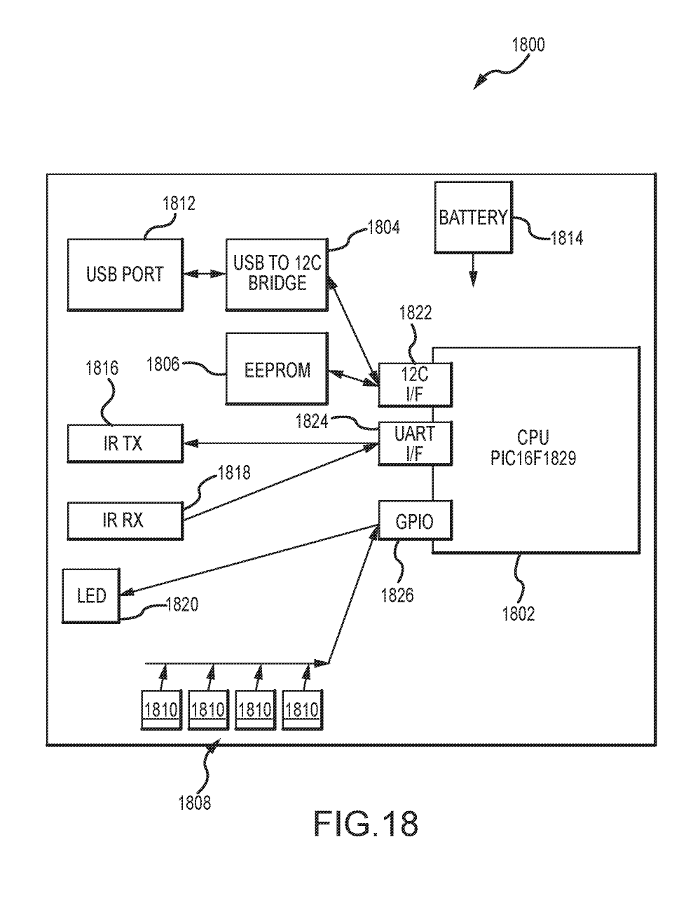

Many other embodiments of provisioning protocols may be utilized to establish data connections between sensors and/or lights in the various systems 1500, 1600. In some embodiments, the system 1500, 1600 has or is configured to communicate with a handheld mobile communication device or control fob that may be brought within close proximity of several devices to execute communication signals and facilitate the provisioning of devices. For example, a control fob or mobile device, such as a smartphone or a tablet computer, may be equipped with provisioning software to cause a light source on the device to flash in a particular coded pattern. In some embodiments, a dedicated device such as a control fob 1800 (see e.g. FIG. 18 and the associated text) that performs flashing, infrared, and/or RF signals may be used. Such mobile devices or control fobs may receive information from individual light and/or sensor devices and relay some or all of the information to the nearest router/gateway. For example, the mobile device or control fob may receive identifying information from each device and relay it to the router/gateway. The router/gateway may then assign addresses to each individual device and send the addresses back to the mobile provisioning device.

Turning back to the provisioning via flashing lights or other communication sequences, such patterns may be detectable to all the LED lights and sensors in a particular room, and may cause the LED lights and sensors to respond by sending information to establish a wireless connection to the local area network. Once the connections are established, the LED lights and sensors may communicate to the router/gateway which pattern or code was used to provision it onto the network. If a group of lights and/or sensors all reported back the same pattern or code used for onboarding, the router/gateway could determine that each of those lights and sensors was located in the same room or area. This information may be further relayed to the cloud component in order to facilitate remote control of lights and sensors in particular areas. Details of dedicated devices and existing devices equipped with software for initiating the provisioning of lights and sensors will be described in greater detail later in this disclosure. [0027] In some embodiments, RF and/or infrared (IR) signals may be used to initiate provisioning protocols, and the signals may be initiated either by handheld devices or by lights or sensors themselves. In embodiments where a light or sensor uses RF and/or IR signals to provision other lights or sensors onto a network, the provisioning protocol may entail detecting the RF and/or IR signal strength of lights and sensors within their range, and using the signal strength to determine which lights and sensors are nearest, and selecting only ones within a particular range to connect. This may facilitate the provisioning of only the devices that are in the same room or area, which may help identify lights and sensors in a particular group.

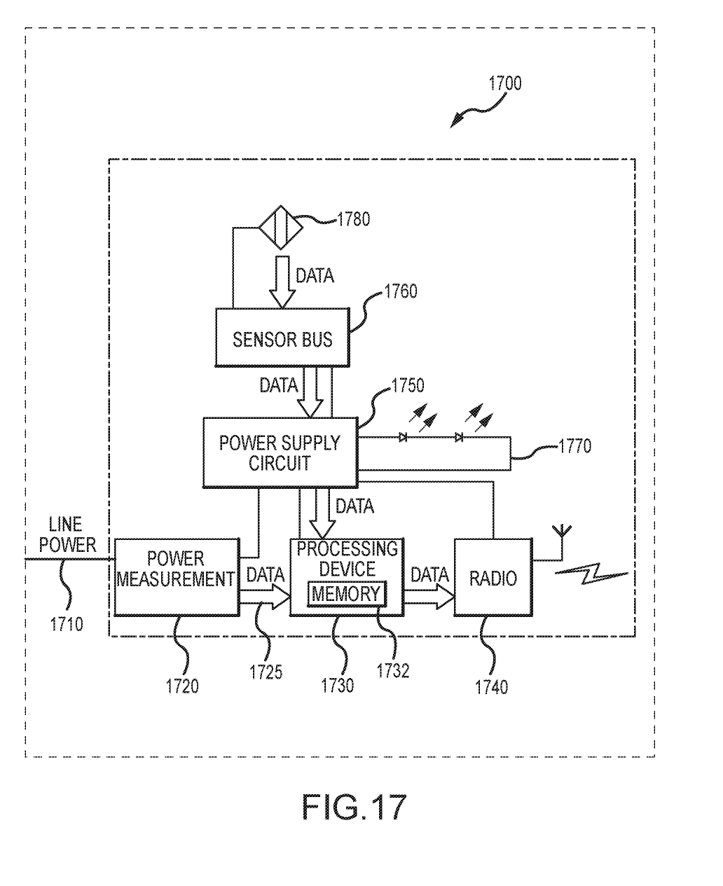

FIG. 17 is a logical block diagram that illustrates a controls-ready light source 1700 and the components thereof that give it the functionality described throughout the disclosure. The block diagram of FIG. 17 is intended to be logical, and should not be construed as a hardware diagram. The light source 1700 may be connected to a power source such as the building AC mains through a line 1710. The light source 1700 having a light engine may include a power measurement circuit 1720 near the input of a power line 1710. This power measurement circuit 1720 may measure parameters associated with power consumption, such as input voltage, input current, Total Harmonic Distortion (THD), and Power Factor (PF). The light source 1700 may also have an analog-to-digital (A/D) converter (not shown), which may convert the analog signals from the power measurement circuit 1720 into digital numerical values and deliver them to a processing device 1730, which may be a microprocessor, as depicted by the data path 1725. The power measurement circuit 1720 may be connected to a power supply circuit 1750, which will be described in more detail in subsequent sections of this disclosure.

In some embodiments, the power supply circuit 1750 may contain an A/D converter circuit, and may deliver digital signals to the processing device 1730, to which it is directly connected. The light source 1700 may also contain a radio or transceiver 1740, which may be or include a radio frequency (RF) and/or infrared (IR) transceiver; in some embodiments, the radio or transceiver 1740 is also connected to or in communication with the processing device 1730. The radio or transceiver 1740 may be generally equipped to transmit and/or receive information via one or more wireless communication protocols now known or as yet to be developed. The processing device 1730 may operate in conjunction with a memory 1732 and/or may comprise or include a field programmable gate array (FPGA) to enable a user to configure the light source 1700 in a suitable manner. The light source 1700 may also comprise a sensor bus 1760, which may receive data from a sensor 1780. Although the sensor 1780 in FIG. 15 is depicted as being within the light source 1700, the sensor 1780 may be external to the light source 1700 in some embodiments.

Regardless of whether the sensor 1780 is external or internal to the physical structure of the LED or light source, the sensor bus 1760 is configured to provide data from the sensor 1780 to the processor 1760, either directly, or via the power supply circuit 1750. The light source 1700 comprises an LED array 1770, which may comprise one or more individual LEDs, and may also be connected to the power supply circuit 1750.

The processing device 1730 may perform several functions of the controls-ready light source 1700. It may regulate the current provided to one or more LEDs in the LED array 1770 when various active or automatic control signals indicate the light should be dimmed or brightened. Active control signals may include signals received from analog on/off switches, or remote signals received from a user, such as at a user interface (see interface 1540 in FIG. 15) within the building or off-site, through the cloud (see cloud 1680 in FIG. 16). Automatic instructions may include stored software instructions to turn lights on and off at a particular time of day. Automatic controls may also include instructions to dim the lights if an internally sensed threshold is reached, such as if the LEDs reach a certain high temperature. Additionally, automatic controls may include instructions to turn the lights on and off in response to input from external sensors, such as if the sensor 1780 were a motion sensor, and its activation prompted the light to turn on.

Another function of the processing device 1730 may be to control a radio or transceiver 1740. For example, the processing device 1730 may execute the conversion of data received from internal or external sensors into a form that complies with one or more of several data protocols in order to transmit messages over the radio or transceiver 1740. The processing device 1730 may additionally provide measurement capability and data transfer from one or more sensors via the sensor bus 1760, which may perform its operations via instructions from the processing device 1730, through an input/output (I/0) channel.

The power supply circuit 1750 may be configured to supply and regulate power to several of the individual components of the light source 1700, even if the individual components have different power requirements. The power supply circuit 1750 may supply power to one or more of the processing device 1730, the radio or transceiver 1740, one or more sensors 1780, and the LED array 1770. For example, the radio or transceiver 1740 may require a voltage of 5 volts, while the LED array 1770 may require a constant current at a varying voltage, depending on whether the LEDs are being turned on or off, or being brightened or dimmed. Additionally, the sensors 1780 may each require different voltages, and the power supply circuit 1750 may be configured to provide the different voltages to each component simultaneously.

In some embodiments, the light source 1700 may have a removable or replaceable card containing either the processor, the radio, or portions or all of both. In some cases, the removable card containing the radio includes a network interface card as known in the art. That is, the PHY (physical) and MAC (media access control) layers that typically provide the foundational capability of the radio/transceiver 1740 to communicate via wireless protocols may be removable. An advantage of having such a removable card is that multiple communication protocols may be used with the controls-ready light fixture. Some protocols may utilize a variety of radio frequencies, infrared frequencies, and/or software kernels, to name a few non-limiting examples, to implement data communication.

In some embodiments, the ability to replace the radio or network card without having to upgrade or change the entire light fixture is provided.

Those skilled in the art will recognize that newer radio protocols requiring newer network cards may also require new instructions at the software layer, which may be stored in the memory and executed at the processor. Therefore, it may be advantageous to have the memory and the processor be removable as well in order to facilitate the re-programming of these components; for example, in secure environments, physical removal for reprogramming or updating may be an alternative to unnecessarily exposing more components to security breaches.

In some embodiments, an FPGA or other programmable processor may be provided in place of or in addition to the processing device 1730, such that updates can be pushed via USB or other connection or the Internet, so as to provide for reprogramming of the processing device 1730 in a manner known to those skilled in the art.

In some embodiments, the cloud-based lighting system 1500, 1600 provides for remote, automated control of all the lights and sensors in a building, while essential and “smart” (i.e., responsive) features of the lights and sensors still function, even if a data connection to either the router/gateway 1515, 1675 or the cloud component 1530, 1680 is interrupted. Those skilled in the art will recognize that that data and/or internet outages and other interruptions will occur from time to time for various reasons; therefore, logic for turning the lights on/off, dimming and other essential functions may be provided within the local software of the lights, so that independent operation is easily accomplished without reliance on the internet connection. Furthermore, any light fixtures that have a hard-wired data connection to a sensor (e.g., a sensor integrated within the light fixture, or an external sensor connected via Ethernet to a light fixture) may continue to function though their wireless connections to the router/gateway may be interrupted. For example, referring back to FIG. 15, the wired sensor 1531 may still communicate sensed motion to the light fixture 1517, and upon receiving that communicated signal, the processor within the light fixture 1517 may turn on.

As stated previously, the controls-ready light source 1700 may store information about communication between the sensor and the light fixture. The light source 1700 may store the time of the signal, the duration, the fact that the light was turned on and off, the resulting temperature of the light, power usage, and any other information that it normally receives and sends to the router/gateway 1515, 1675. If the light source 1700 is hard-wired to or comprises multiple sensors, such as energy usage or organic compound sensors 1780, the light source 1700 may store any data received from those sensors as well. Once the wireless data connection 127 is restored, the controls-ready light source 1700 may transmit the stored information to the router/gateway 1515, 1675 and the cloud component 130, 280. The cloud component 1530 can then analyze the stored data, detect any unusual activity, and report it back to the client or user 1540, 1550. Such data may be especially useful if the interruption to the wireless communication was due to a security or safety concern, such as a cyberattack or a natural disaster. Functioning sensors could still record, for example, unauthorized individuals in a building, smoke from a fire, and electrical short from a power surge, or water damage from a flood. The ability for each controls-ready light source 1700 to transmit stored information once the data connection is restored provides the benefit to the client or user to identify problems in a large building very quickly.

In some embodiments, the lighting devices and sensors that are provisioned in groups may comprise sub-networks within the larger networks of all the devices in communication with a router, and all the routers and the cloud component in communication with each other. These networks may form a “hierarchy” from highly localized networks to wider networks. An advantage to this hierarchy of networks is that there is a high level of control at the most local level, even as between one LED and one sensor, but there are also “failover” properties. In other words, the sensors connected to a particular light can invoke local decision making software, so if, for example, motion is detected, lights are turned on, or if high quantities of dangerous gas are detected, lights flash. In addition, if this same light and sensor detects that it is still connected to the wider network beyond the two devices, (e.g., to multiple routers) it can signal other lights to turn on or flash as well. If a wider network connection, such as an internet or cellular connection is detected, the light or sensor could signal for help. Because there are multiple types of connections between the lights, sensors, routers, and cloud in a hierarchy of networks, a light or sensor may detect if one of its normal connection routes has failed and can re-route communication to through other connections.

The systems and methods described herein can be implemented in a computer system, in addition to the specific physical devices described herein. As previously described herein, FIG. 14 shows a diagrammatic representation of one embodiment of a computer system 1400 within which a set of instructions can execute for causing a device to perform or execute any one or more of the aspects and/or methodologies described herein, such as with reference to FIGS. 15-21.

The router/gateway 1515, 1675, alone or in conjunction with the cloud component 1530, 1680 and/or the client or user 1540, 1550 in FIGS. 15-16 illustrate some functions of the computer system 1400. The sensors 1531, 1532 of FIG. 15, and the controls-ready light source 1700 of FIG. 17 illustrate other implementations of the computer system 1400. Again, the components in FIG. 14 are examples only and do not limit the scope of use or functionality of any hardware, software, firmware, embedded logic component, or a combination of two or more such components implementing particular embodiments described herein.

Turning now to FIG. 18, a control fob 1800 for initiating firmware updates and commissioning activities related to the systems 100, 400 and light sources 1700 previously described herein is now described in more detail. As mentioned previously in this document, radio frequency (RF) and/or infrared (IR) signals may be used to commission and/or update a light source 117, 118, 1621a-1621d, 1700, which may be an LED light source.

Those skilled in the art will understand that RF and IR signals have distinct advantages and disadvantages in communicating with an LED or a number of LEDs. For example, RF signals are not necessarily room-specific—see, for example, the restroom 240 in FIG. 2; here, an RF signal may inadvertently communicate with devices in the utility closet 1650 or office 1630, due to RF waves being capable of passing through walls. In such spaces, it may be appropriate for a user or commissioning device to communicate with the LEDs in these rooms by way of IR communication, which does not pass through walls. That is, an IR transceiver might be suitable to limit the intended communication to the selected room. Conversely, an IR signal used in a larger room is more prone to being blocked by, for example, furniture or other structures in the room. For example, the room 210 illustrated in FIG. 2 is relatively large and more likely to have other structures, such as support columns, therein. RF communication may be suitable for communication in such examples. That is, the LEDs may be selectively designed such that a first LED is configured to receive commissioning/update instructions by way of RF signals only, and a second LED is configured to receive commissioning/update instructions by way of IR signals only. In some embodiments, an LED may be configured to receive commissioning/update instructions by either RF or IR signals. In some embodiments, an LED may be configured to be programed after field installation to be responsive to only one type of signal.

As previously described herein, a light engine coupled with an LED 117, 118, 1621a-1621d, 1700 may communicate wirelessly with a master gateway 1515, 1675 using an Enocean radio or other transmission means. After the LED 117, 118, 1621a-1621d, 1700 is installed and powered up, it may begin sending out a “beacon” message to indicate its presence and that it is “unpaired”.

The user may then put the LED 117, 118, 1621a-1621d, 1700 into a pairing request mode through use of a control fob 1800. The user may put the LED 117, 118, 1621a-1621d, 1700 into pairing request mode by aiming the control fob 1800 at the light engine and pressing a first button 1810 or user input 508. An indicator 1820 may blink red once, indicating that the control fob 1800 has sent a pairing request message via the infrared (IR) transmitter 1816 to the light engine. This will cause the light to turn off to indicate that it is in pairing mode. The light engine in the LED 117, 118, 1621a-1621d, 1700 may now begin sending out a message over the radio to the gateway 1515, 1675 indicating that it is ready to be paired. The gateway 1515, 1675 may then send a message via the radio or transceiver to the light engine in the LED 117, 118, 1621a-1621d, 1700 with the gateway's ID, effectively pairing it with the gateway 1515, 1675. Finally, the gateway 1515, 1675 may send a “paired” message via the radio to the light engine in the LED 117, 118, 1621a-1621d, 1700, which may cause the light to blink ON-OFF-ON. The LED 117, 118, 1621a-1621d, 1700 is now paired with the gateway 1515, 1675, and further commissioning of the light engine or LED 117, 118, 1621a-1621d, 1700 can be accomplished over the Enocean radio or any other transmission means as previously described herein.

The control fob 1800 may include a processing device such as a microcontroller 502, a USB to I2C bridge 504, a storage device 506 having enough nonvolatile storage (such as EEPROM) to hold the light engine firmware for controlling the light engine, which may reside in one or more LEDs 117, 118, 1621a-1621d, 1700 as illustrated in FIGS. 1-3, and may include an LED chip(s) mounted on a circuit board(s). The control fob 1800 may also have a user input 508, which may include a plurality of buttons 1810 to initiate firmware update and commissioning activities. The control fob 1800 may also have a USB port 512, a battery 514, and bi-directional infrared (IR) communication capabilities including an IR transmitter 1816 and an IR receiver 1818.

The USB port 512 may be used to connect to a PC or other computing device 400, such as a client or user interface 140, 150, for uploading light engine firmware and light engine non-volatile memory or EEPROM data into the storage device 506 of the control fob 1800. A virtual com port may be enumerated on the computing device when connecting to a computing device 140, 150, 400 via the USB port 512. The IR transceiver including transmitter and receiver 1816, 1818 are used for communication with the light engine of the LED 1700, which must also have IR transmitter and receiver capabilities, such as an IR transceiver 1740 (see e.g. FIG. 17). In some embodiments, new light engine firmware and any light engine non-volatile memory EEPROM data are sent from the control fob 1800 over an infrared link between the control fob transmitter and receiver 1816, 1818 and the transceiver 1740. The user input 508 or plurality of buttons 1810 may be configured to initiate light engine firmware updates, light engine non-volatile memory or EEPROM data updates and/or light engine commissioning in response to a user input.

In some embodiments, the control fob 1800 has an indicator 1820, such as an indicator LED that is used to indicate transfer status during light engine firmware or non-volatile memory updating. In some embodiments, the indicator 1820 is also used to indicate initiation of light engine commissioning. The storage device 506 may contain 65535 bytes of storage, or whatever amount of storage is sufficient to hold all of the light engine firmware and light engine non-volatile memory storage values. Those skilled in the art will understand that the microcontroller 502 may be configured to communicate with the bridge 504, the storage device 506, the IR transmitter, 1816, the IR receiver 1818, the indicator 1820, and/or the user input 508 by way of a 12 channel bus or other power interface 522, a universal asynchronous receiver/transmitter or UART interface 524, and/or input/output means such as a general-purpose input/output or GPIO 526 respectively, in a manner known in the art.

As illustrated in FIG. 5, the control fob 1800 may have four buttons 1810 for user input. A first button may be used for commissioning, a second button may be used for updating light engine firmware, and a third button may be used for updating light engine non-volatile memory or EEPROM values. A fourth button may be provided to enable future expansion of functions, back up functions and/or any other number of features.

After new light engine firmware is loaded onto a control fob 1800, such as via a PC application, a mobile application, a cloud application, or other means, a user may initiate a light engine firmware update, such as, for example, by be pressing and holding the second button for at least a predetermined length of time, such as about 4 seconds. At this point, the control fob 1800 may be configured to activate the indicator 1820, for example, by causing an LED in the indicator 1820 to turn on green, indicating that it is waiting for the light engine to enter bootloader mode. The indicator 1820 may then start blinking green when transfer of new firmware to the light engine begins. If communication problems arise, the indicator 1820 may turn solid red. For example, if the IR receiver 1818 and transmitter 1816 are not pointed at the light engine, or if the control fob 1800 is too far away or is obscured from the light engine, proper communication is not established.

In response to the indicator 1820 turning red, a user may resume the firmware update by properly pointing the control fob 1800 at the light engine and ensuring the control fob 1800 is close enough to the light engine, with nothing obscuring the line of sight. If communications cannot be re-established, the update will eventually time out and the indicator 1820 may rapidly blink 5 times red, indicating that the update is aborted. If communication is re-established, the indicator 1820 may start blinking green. After a successful firmware update, the indicator may rapidly blink 5 times green and then turn off.

At this point, the light engine is configured to reset and start executing the new firmware.

Similarly, after new light engine non-volatile memory or EEPROM values are loaded onto the control fob 1800, such as via a PC application, a mobile application, a cloud application, or other means, a user may initiate a light engine non-volatile memory update. For example, a user may press and hold a third button for a preselected period of time, such as at least 4 seconds, to initiate a light engine non-volatile memory update. In response, the indicator 1820 may turn on green, indicating that it is waiting for the light engine to enter bootloader mode. The indicator 1820 may then start blinking green when transfer of new non-volatile memory values to the light engine begins. If communication problems arise (such as those previously described), the indicator 1820 may turn solid red, and a user may resume the non-volatile memory update in a manner substantially as described with reference to resuming the light engine firmware update. At this point the light engine is configured to reset and start executing, using the new non-volatile memory values.

In some embodiments, the control fob 1800 further comprises an RF transceiver that functions substantially as previously described herein with reference to the IR transmitter/receiver 1816, 1818; however, those skilled in the art will understand that pointing the control fob 1800 directly at the light engine is not necessary, as the signals will transmit in all directions. Moreover, the RF transceiver may control all LEDs 1517, 1518, 1621a-1621d, 1700 in a given 3-dimensional zone, regardless of whether the LEDs 1517, 1518, 1621a-1621d, 1700 are in the same room. In some embodiments, the control fob 1800 resides as an application in a mobile phone application.

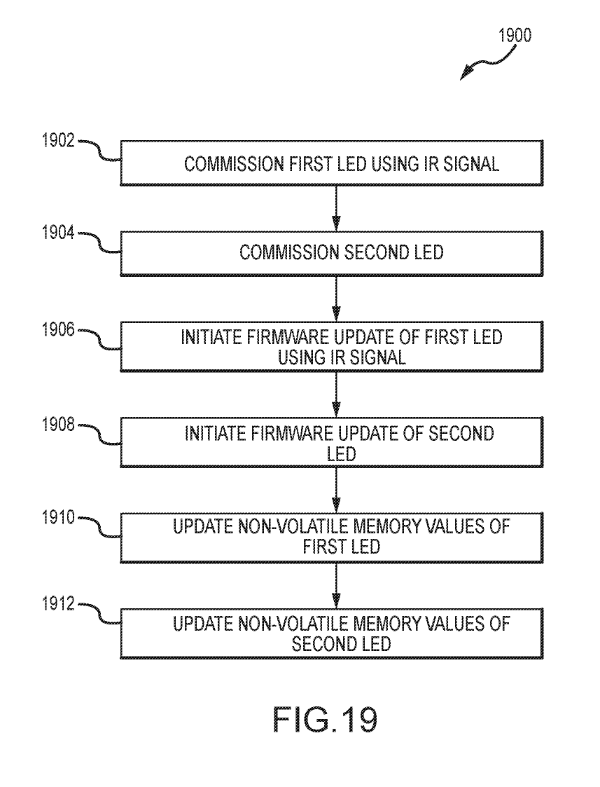

Turning now to FIG. 19, a method 1900 of interfacing with a plurality of LED lights is now disclosed. The method 1900 includes commissioning 1902 a first LED using an IR signal such as that provided in an IR transceiver or as previously described herein. In some embodiments, the IR signal may be provided by a control fob, which may reside is a mobile phone device. The method 1900 further includes commissioning 2004 a second LED. In some embodiments, commissioning 2004 of the second LED is achieved by using an IR signal. In some embodiments, commissioning 1904 of the second LED is achieved by using an RF signal. The method 1900 further includes initiating 1906 a firmware update of a first LED using an IR signal, initiating 1908 a firmware update of a second LED, updating 1910 non-volatile memory values of a first LED, and updating 1912 non-volatile memory values of a second LED. In some embodiments, initiating 1908 a firmware update of the second LED is achieved by using an IR signal. In some embodiments, initiating 1908 a firmware update of the second LED is achieved by using an RF signal. In some embodiments, updating 1912 non-volatile memory values of the second LED is achieved by using an IR signal. In some embodiments, updating 1912 non-volatile memory values of the second LED is achieved by using an RF signal. In some embodiments, the method 1900 is achieved by using a control fob 1800 feature on a mobile phone.

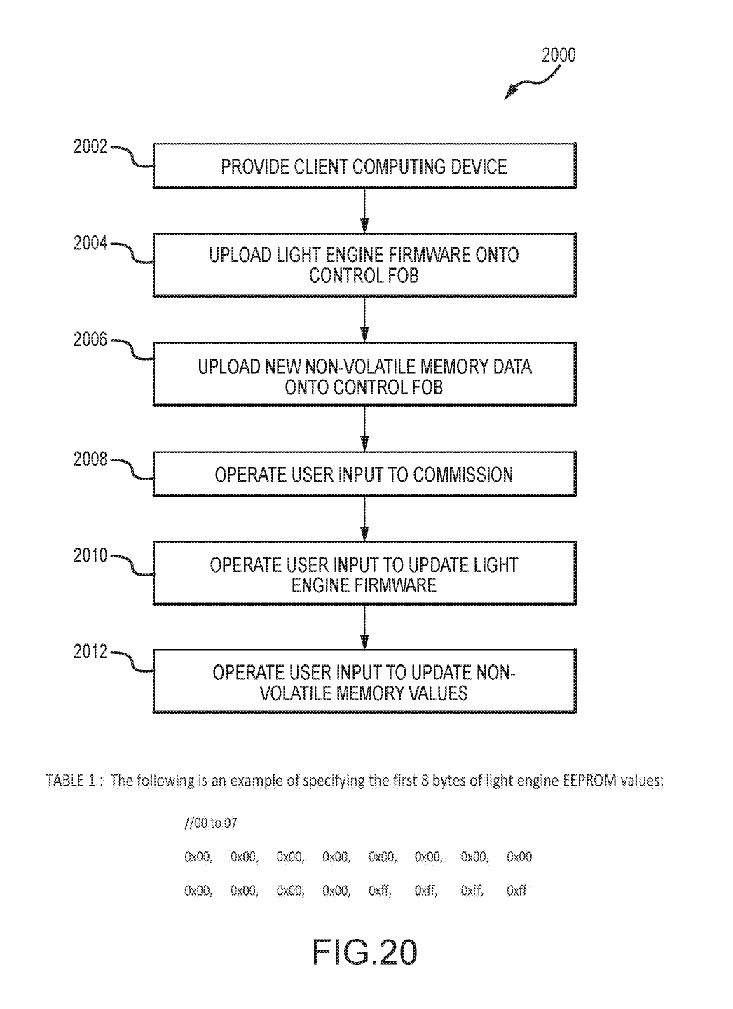

Turning now to FIG. 20, a process 2000 for updating light engine firmware may start on a computing device such as a Windows based PC by providing 702 a client computing device, such as the device 140, 150 previously described herein. First, the new version of light engine firmware may be uploaded 704 onto the control fob 1800. To do this, a USB cable may be connected between the computing device 140, 150 and the control fob 1800, which may create a virtual com port on the computing device 140, 150. In some embodiments, the Intel Hex file format is used, because the file format is very common. A computing application may be used to load and parse the firmware hex file and then convert the firmware to binary format and upload it to the control fob non-volatile memory via USB. If there is any non-volatile memory data specified in the hex file targeted for the light engine, this will also be uploaded 1906 to the control fob EEPROM 506. Additionally a 16 bit CRC may be calculated for all of the firmware and uploaded, along with the number of bytes of firmware, to the control fob non-volatile memory or EEPROM 506 (these are needed by the light engine bootloader). Now the control fob 1800 is configured for performing firmware update and commissioning tasks for individual LED light engines.

Continuing with FIG. 20, a user may operate 708 a first user input, such as a first button 1810 to commission a light engine in a manner substantially as previously described herein. A user may also operate 710 a second user input, such as a second button, to update light engine firmware in a manner substantially as previously described herein. In some embodiments, a user may operate 1912 a third user input, such as a third button, to update light engine non-volatile memory values in a manner substantially as previously described herein.

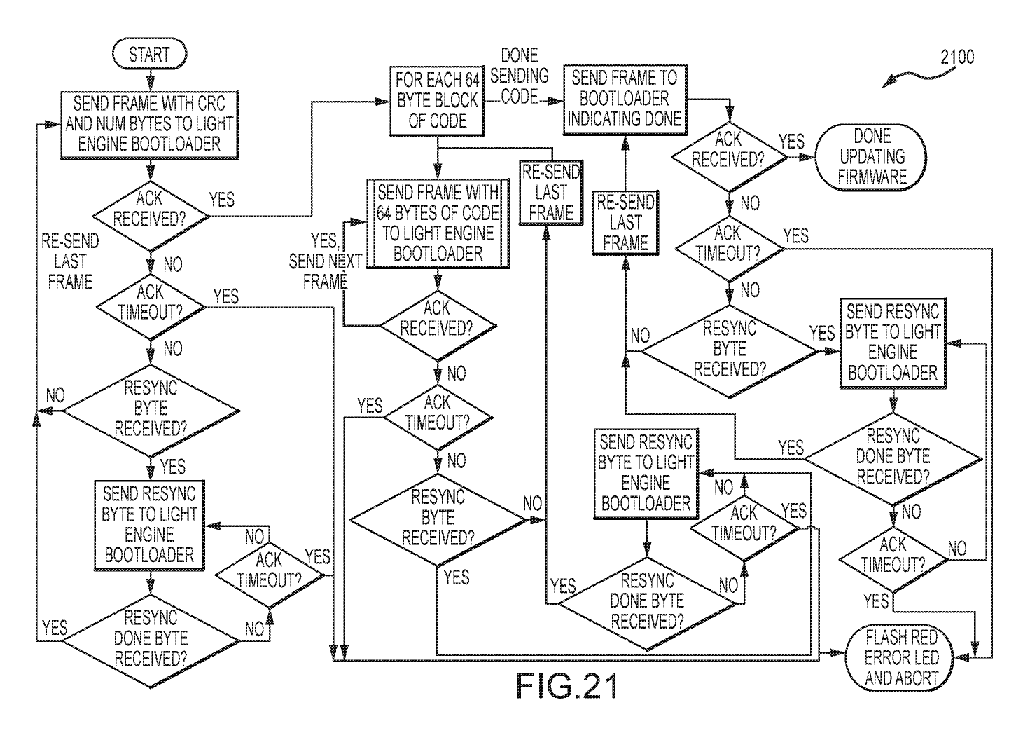

FIG. 21 illustrates a detailed flowchart 2100 of one embodiment of the process 2000 and how the control fob 1800 might be used. For example, light engine non-volatile memory values present in a specified Intel Hex file may be uploaded to the control fob 1800 by an application or device 1540, 1550. Additional functionality may be included in the PC application that allows specifying an optional file containing light engine non-volatile memory values in a CSV format. The values may be all specified in hex, and the non-volatile memory address offset may start at zero for the first value and increments for each subsequent value. Comments are allowed in the file and must begin with “//”. Everything after the comment delimiter is ignored. To allow the user to pick only certain non-volatile memory or EEPROM values to be changed, each line of CSV values may be followed by a line of “mask” values. If a mask value is 0×ff, the corresponding value in the line above may be written to EEPROM. If a mask value is 0×00, the EEPROM value at that offset is not changed. In this case the CSV value specified above is ignored.

TABLE 1 is an example of specifying the first 8 bytes of light engine EEPROM values. That is, the first line is a comment indicating the offset range. The second line are the first 8 values, and the third line are the masks corresponding to each value. In TABLE 1, the first four values are not changed and the second four values are zeroed out.

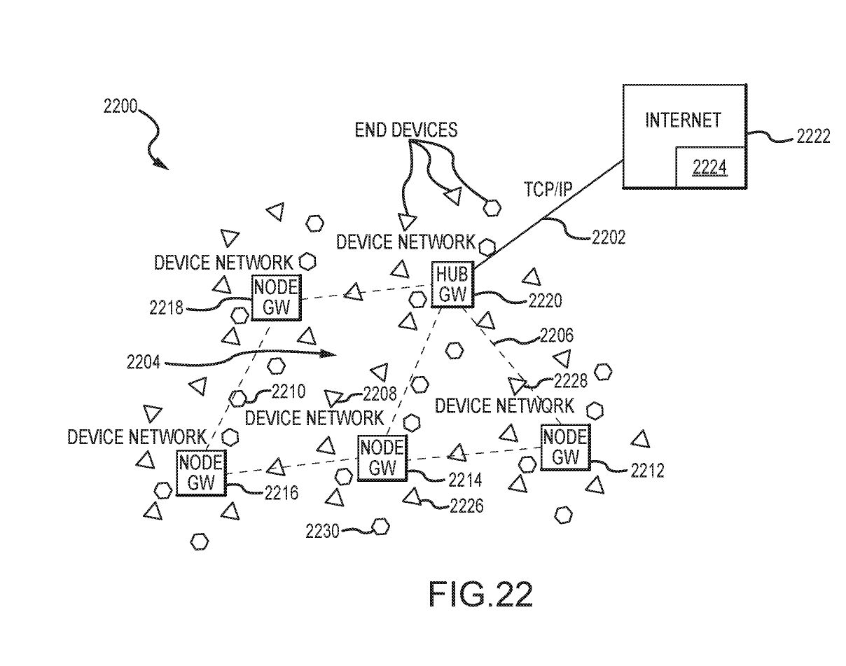

As illustrated in FIG. 22, in some embodiments, multiple gateways may be connected with a single network connection.

For example, a system 2200 may have a single internet connection 2202 from a hub gateway 2220, a device network 2204, and a gateway network 2206. The internet connection 2202 and the device network 2204 may include components substantially similar to those previously described herein with reference to FIGS. 1-21, and including, for example, a commission ready light system 1700, computer system 1400, etc.

The internet connection 2202 may include a TCP/IP connection through an Ethernet or WiFi connection, but may be any suitable internet connection 2202. The device network 2204 may be either wired or wireless (e.g., Zigbee, Bluetooth, Z-Wave, EnOcean, Thread, etc.), such that a first of a plurality of devices 2208 may communicate with a second of a plurality of devices 2210.

The gateway network 2206 may include a network connecting one or more node gateways 2212, 2214, 2216, 2218 to one or more hub gateways 2220. To send data from the end devices 2208, 2210 to the internet 2222, each node gateway 2212 may receive each end device communication over the device network 2204 and transmit the data over the gateway network 2206 to the hub gateway 2220. The hub gateway 2220 may relay the data or related messages to one or more internet applications 2224, such as the central application 1116 residing on a web-based server as shown in FIGS. 11A and 11B, by way of the internet connection 2202.

The internet application(s) 2224, may send data to or communicate with individual devices 2208, 2210 using the reverse process: messages, control signals, data, etc. may be sent to through an internet connection 2202 to the hub gateway 2220; the hub gateway 2220 may then communicate the message, control signal, data, etc. to the appropriate node gateway(s) 2212, 2214, 2216, 2218 by way of the gateway network 2206. The node gateway(s) 2212, 2214, 2216, 2218 may then relay a message, control signal, data, etc. to one or more end devices 2208, 2210 by way of the device network 2204.

The device network 2204 may include any suitable communication protocol, including, but not limited to, Zigbee, Bluetooth, Z-Wave, EnOcean, Thread, etc.

The gateway network 2206 may include any suitable communication protocol including, but not limited to, Zigbee, Bluetooth, Z-Wave, EnOcean, Thread, etc.

In some embodiments, the device network 2204 uses a protocol that is different from that of the gateway network 2206. In some embodiments, the device network 2204 uses the same protocol used by the gateway network 2206. In some embodiments, the device network 2204 uses the same protocol with a different channel.

The device network 2204 and/or the gateway network 2206 may be a mesh network.

In some embodiments, the hub gateway 2220 and the node gateway(s) 2212 are configured to perform different actions depending on the content and urgency of different messages. For example, a node gateway 2212 may be configured with a default communication system in which the node gateway(s) 2212 will generally queue messages for end devices 2208, 2210, and then bundle these messages together in a single transmission over the device network 2204. This default improves efficiency by reducing the overhead associated with each individual transmission over the device network 2204. The node gateway(s) 2212 may also be configured with an override communication system in which the node gateway(s) 2212 will pass urgent and/or time-critical messages over the device network 2204 immediately, even if this is less efficient. In some embodiments, one or more of the node gateway(s) 2212, the hub gateway 2220, or the application 2224 determine which message(s) are urgent and/or time-critical, and the override communication system is responsive to determining the message(s) are urgent or time-critical. In some embodiments, the device network 2204 may provide a network of devices including, for example, light sources 117, 1102, motion sensors 1110, an imaging device 1014, and/or other devices as previously described herein with reference to FIGS. 1-21.

Continuing with FIG. 22, a three-network solution having a device network 2204, a gateway network 2206, and an internet connection 2202 may allow the system 2200 to use the best communication system or protocol for each link in the chain between internet 2224 and device 2208. In some embodiments, the EnOcean protocol is used for the device network 2204, which may maximize energy efficiency and/or benefit energy harvesting end devices 2226.

In some embodiments, a mesh network is provided for plugged-in devices 2228, sparse, dispersed devices 2230, and/or node gateways 2212.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Within this specification, the same reference characters are used to refer to terminals, signal lines, wires, etc. and their corresponding signals. In this regard, the terms “signal,” “wire,” “connection,” “terminal,” and “pin” may be used interchangeably, from time-to-time, within the this specification. It also should be appreciated that the terms “signal,” “wire,” or the like can represent one or more signals, e.g., the conveyance of a single bit through a single wire or the conveyance of multiple parallel bits through multiple parallel wires. Further, each wire or signal may represent bi-directional communication between two, or more, components connected by a signal or wire as the case may be.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a processor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of installing devices on or in a structure, the method comprising:
retrofitting a plurality of devices to a structure, the plurality of devices being network-ready;
causing a central application to:
(a) register the plurality of devices on a device network, the device network in communication with the central application;
(b) associate a location of at least one of the plurality of devices with the at least one of the plurality of devices;
(c) associate a human-understandable identifier with the at least one of the plurality of devices;
(d) associate the at least one of the plurality of devices with a network address;
(e) group a first one of the plurality of devices with a second one of the plurality of devices, the grouping responsive to determining that the first one of the plurality of devices and the second one of the plurality of devices are at least one of in the same room, in the same service system, or of the same type;
(f) assign a trigger to the first one of the plurality of devices; and
(g) assign a first automated function to the first one of the plurality of devices and a second automated function to the second one of the plurality of devices, the automated functions of the first and second ones of the plurality of devices responsive to the trigger of the first one of the plurality of devices.

2. The method of claim 1, wherein:
the second automated function is different from the first automated function.

3. The method of claim 1, wherein:
the registering comprises transferring data from an imaging device to the central application;
the associating the location of at the least one of the plurality of devices with the at least one of the plurality of devices is responsive to the transferring data; and
the associating the human-understandable identifier with the at least one of the plurality of devices is responsive to the transferring data.

4. The method of claim 3, further comprising:
creating at least one of a 2D schematic or a 3D model of the structure, the 2D schematic or 3D model including the location of the at least one of the plurality of devices.

5. The method of claim 1, wherein:
the plurality of devices comprises a first retrofitted light source and at least one of a second retrofitted light source, a motion sensor, a light switch, a thermostat, a networked HVAC vent, a computer, a television, a moisture sensor, a light sensor, a door sensor, a window sensor, a decibel meter, or a hotel key card switch.

6. The method of claim 5, further comprising:
causing an infrared signal from a control fob to commission at least one of the plurality of devices.

7. The method of claim 6, further comprising:
causing a radio frequency signal from the control fob to commission at least one of the plurality of devices.

8. The method of claim 5, further comprising:
causing a radio frequency signal from the control fob to commission at least one of the plurality of devices, the radio frequency signal and the device network have a first communication protocol;
causing an infrared signal from a control fob to commission at least one of the plurality of devices, the infrared signal having a second communication protocol, the second communication protocol different from the first communication protocol.

9. The method of claim 1, further comprising:
providing the device network having a first communication protocol;
providing a gateway network having a hub gateway and a plurality of node gateways, the gateway network having a second communication protocol; and
providing an internet connection in communication with the hub gateway.

10. The method of claim 9, wherein:
the first communication protocol is different from the second communication protocol; and
the internet connection is a single internet connection for providing communication between the hub gateway and the central application.

11. The method of claim 1, wherein:
the central application is an application distributed across one or more hardware components, software components, or firmware components.

12. The method of claim 1, further comprising:
tracking movement of an object or person in the structure by way of wireless triangulation; wherein
the tracking is responsive to the registering the plurality of devices on a device network, the associating a location of at least one of the plurality of devices with the at least one of the plurality of devices, and the associating a human-understandable identifier with the at least one of the plurality of devices.

13. A system of devices on or in a structure, the system comprising:
a plurality of devices coupled to a structure, the plurality of devices being network-ready;
a central application comprising non-transitory processor-readable instructions or an FPGA for executing a method, the method comprising:
a) registering the plurality of devices on a device network;
b) associating a location of at least one of the plurality of devices with the at least one of the plurality of devices;
c) associating a human-understandable identifier with the at least one of the plurality of devices;
d) associating the at least one of the plurality of devices with a network address;
e) grouping a first one of the plurality of devices with a second one of the plurality of devices, the grouping responsive to determining that the first one of the plurality of devices and the second one of the plurality of devices are at least one of in the same room, in the same service system, or of the same type;
f) assigning a trigger to the first one of the plurality of devices; and
g) assigning a first automated function to the first one of the plurality of devices and a second automated function to the second one of the plurality of devices, the automated functions of the first and second ones of the plurality of devices responsive to the trigger of the first one of the plurality of devices.

14. The system of claim 13, wherein:
the second automated function is different from the first automated function.

15. The system of claim 13, wherein:
the registering comprises transferring data from an imaging device to the central application;
the associating the location of the at least one of the plurality of devices with the at least one of the plurality of devices is responsive to the transferring data; and
the associating the human-understandable identifier with the at least one of the plurality of devices is responsive to the transferring data.

16. The system of claim 15, wherein:
the registering comprises creating at least one of a 2D schematic or a 3D model of the structure, the 2D schematic or 3D model including the location of the at least one of the plurality of devices.

17. The system of claim 13, wherein:
the plurality of devices comprises a first retrofitted light source and at least one of a second retrofitted light source, a motion sensor, a light switch, a thermostat, a networked HVAC vent, a computer, a television, or a moisture sensor, a light sensor, a door sensor, a window sensor, a decibel meter, or a hotel key card switch.

18. The system of claim 17, wherein:
at least one of the plurality of devices is responsive to an infrared signal from a control fob.

19. The system of claim 18, wherein:
at least one of the plurality of devices is responsive to a radio frequency signal from the control fob.

20. The system of claim 17, wherein:
at least one of the plurality of devices is configured for commissioning in response to a radio frequency signal from a control fob, the radio frequency signal and the device network having a first communication protocol;
at least one of the plurality of devices is configured for commissioning in response to an infrared signal from the control fob, the infrared signal having a second communication protocol, the second communication protocol different from the first communication protocol.

21. The system of claim 13, further comprising:
a device network having a first communication protocol;
a gateway network having a hub gateway and a plurality of node gateways, the gateway network having a second communication protocol; and
an internet connection in communication with the hub gateway.

22. The system of claim 13, wherein:
the first communication protocol is different from the second communication protocol; and
the internet connection is a single internet connection for providing communication between the hub gateway and the central application.

23. The system of claim 13, wherein:
the central application is an application distributed across one or more hardware components, software components, or firmware components.

24. The system of claim 13, wherein:
the method further comprises tracking movement of an object or person in the structure by way of wireless triangulation; wherein
the tracking is responsive to the registering the plurality of devices on a device network, the associating a location of at least one of the plurality of devices with the at least one of the plurality of devices, and the associating a human-understandable identifier with the at least one of the plurality of devices.

25. A central application for controlling a system of devices on or in a structure, the system comprising a plurality of devices coupled to a structure, the plurality of devices being network-ready, the central application comprising:
non-transitory processor-readable instructions or an FPGA for executing a method, the method comprising:
a) registering the plurality of devices on a device network;
b) associating a location of at least one of the plurality of devices with the at least one of the plurality of devices;
c) associating a human-understandable identifier with the at least one of the plurality of devices;
d) associating the at least one of the plurality of devices with a network address;
e) grouping a first one of the plurality of devices with a second one of the plurality of devices, the grouping responsive to determining that the first one of the plurality of devices and the second one of the plurality of devices are at least one of in the same room, in the same service system, or of the same type;
f) assigning a trigger to the first one of the plurality of devices; and
g) assigning a first automated function to the first one of the plurality of devices and a second automated function to the second one of the plurality of devices, the automated functions of the first and second ones of the plurality of devices responsive to the trigger of the first one of the plurality of devices.

26. The application of claim 25, wherein:
the second automated function is different from the first automated function.

27. The application of claim 25, wherein the method comprises:
registering the plurality of devices on the device network, the device network having a first communication protocol; and
communicating with a gateway network via an internet connection in communication with a hub gateway in the gateway network, the gateway network having a hub gateway and a plurality of node gateways, the gateway network having a second communication protocol.

28. The application of claim 25, wherein:
the application is distributed across one or more hardware components, software components, or firmware components.

29. The application of claim 25, wherein:
the method further comprises tracking movement of an object or person in the structure by way of wireless triangulation; wherein
the tracking is responsive to the registering the plurality of devices on a device network, the associating a location of at least one of the plurality of devices with the at least one of the plurality of devices, and the associating a human-understandable identifier with the at least one of the plurality of devices.
